(19) United States
(12) Patent Application Publication
(10) Pub. No.: US 2021/0125138 A1
(43) Pub. Date: Apr. 29, 2021

(54) ORDER MANAGEMENT APPARATUS, ORDER MANAGEMENT METHOD, AND ORDER MANAGEMENT PROGRAM

(71) Applicant: HITACHI TRANSPORT SYSTEM, LTD., Tokyo (JP)

(72) Inventors: Hiroshi Yoshitake, Tokyo (JP); Yoriko Kazama, Tokyo (JP); Ryota Kamoshida, Tokyo (JP); Masaharu Kondou, Tokyo (JP)

(73) Assignee: HITACHI TRANSPORT SYSTEM, LTD., Tokyo (JP)

(21) Appl. No.: 16/074,140

(22) PCT Filed: Mar. 2, 2016
(86) PCT No.: PCT/JP2016/056465

§ 371 Date: Jul. 31, 2018

(51) Int. Cl. G06Q 10/08; G06Q 10/06; B65G 47/84

(52) U.S. Cl. CPC G06Q 10/087; B65G 47/845; G06Q 10/06398; G06Q 10/0836

(57) ABSTRACT

An order management apparatus executes reception processing to receive at least one order, the number of pieces of the articles to be issued out and delivery destinations of the articles to be issued out; determination processing to determine likelihood of conflict on a specific delivery shelf before the issuing-out operation based on whether, while the issuing-out operation is completed since the specific delivery to store the articles has been transported to a first working station, an instruction on the issuing-out operation for the articles to be issued out from the specific delivery shelf at the second working station occurs; and setting processing to set the number of pieces of the articles to be issued out to be stored within the specific delivery shelf or between the specific delivery shelf and another delivery shelf based on the determination on the likelihood of the conflict on the specific delivery shelf.

### TECHNICAL FIELD

The present invention relates to an order management apparatus, an order management method and an order management program all to control order.

### BACKGROUND ART

Within a warehouse or a factory, such issuing-out job is carried out as an operator collecting articles stored therein according to an order and sorting out such collected articles to an issue-out destination. During such issuing-out job, a picking system, in which such stored articles are carried over to an operator by an automated carriage, is operated in practice. In Patent Literature 1 below, in a distribution warehouse, there is disclosure on such a technique as the picking operation being carried out by the target articles or the shelves, in which such target articles are stored, being carried over by an auto carriage to the place where an operator in charge of issuing out such articles is present.

Further, normally, at a distribution warehouse or an assembly factory, plural types of articles are controlled by the unit of bucket or pallet. In the case where there are stored articles in inventory at a distribution warehouse or an assembly factory, the number of issued-in articles reduces according as the issuing-out job proceeds further. Thus, the distribution warehouse or the assembly factory is issued-in or replenished with articles on a regular basis. As the result of the issuing-out and issuing-in jobs being repeated, certain types of articles are distributed to different storage areas, so that the extra storage area in which new types of articles can be charged reduces.

Accordingly, it causes the filling rate of articles in inventory to deteriorate or it requires that plural different buckets or pallets be called for to the place where the issuing-out operation is performed in order to pick the necessary number of certain kinds of articles, which leads to deteriorating productivity.

Thus, for instance, there is disclosure in Patent Literature 2 below on the method of stowing together the same kind of articles distributed into a plurality of buckets into the smaller number of buckets as much as possible by defining the upper limit of the size and the number of pieces of articles allowable for a bucket each and every kind of articles. Further, in Patent Literature 3 below, there is disclosure on the method of stowing together plural kinds of articles according to volume limitation.

### CITATION LIST

### Patent Literature

Patent Literature 1: U.S. Pat. No. 8,805,573

Patent Literature 2: US Patent Application Publication No. 2007-186320

Patent Literature 3: US Patent Application Publication No. 2005-206317

### SUMMARY OF INVENTION

### Technical Problem

However, the prior inventions disclosed in Patent Literatures 2 and 3 are faced with the following problems. The delivery shelves in which plural kinds of articles are stowed together are carried over to the working stations by an automated carriage according to the issuing-out instruction. In the case where the issuing-out operations simultaneously proceed at the plurality of working stations (e.g., WS1 and W2 exemplified herein), there are some cases where certain articles A stowed together with other articles in a certain delivery shelf X are needed at the working stations WS 1 and WS2.

While the articles A are picked from the delivery shelf X at the working station WS1, the time lag occurs at the other working station WS2 until the delivery shelf X reaches there, which leads to deteriorating productivity.

Further, when plural articles whose types are different from one another are picked to a destination assigned to the working station and each type of such articles is stowed in a different delivery shelf, each and separate delivery shelf must be carried over to the working station, which unnecessarily leads to increasing the times of carrying the delivery shelves over to the working station so as to increase the idling time and in turn deteriorate productivity.

The present invention envisages improving on the efficiency with which the issuing-out operation is performed.

### Solution to Problem

The order management apparatus, order management method and order management program according to one aspect of the present invention are such that the issuing-out operation of the target articles to be issued out is managed by means of a plurality of delivery shelves to store articles and a plurality of working stations to issue out the articles stored in the delivery shelves transported to the working stations, in which the order management apparatus includes a processor to execute a program and a memory device to store the program, and the processor executes reception processing to receive at least one order including the articles to be issued out, the number of pieces of the articles to be issued out and delivery destinations of the articles to be issued out; determination processing to determine likelihood of conflict on a specific delivery shelf before the issuing-out operation of the articles to be issued out based on the order that while the issuing-out operation is over since the specific delivery shelf to store the articles to be issued out has been transported to the first working station, an instruction on the issuing-out operation for the articles to be issued out from the specific delivery shelf at the second working station occurs; and setting processing to set the number of pieces of the articles to be issued out to be stored within the specific delivery shelf or between the specific delivery shelf and another delivery shelf based on the determination on the likelihood of the conflict on the specific delivery shelf.

### Advantageous Effects of Invention

According to the representative embodiment of the present invention, it allows the efficiency with which the issuing-out operation is performed to be enhanced. The technical problems, features and advantageous effects other than described above are clarified according to the explanations of the following examples.

### BRIEF DESCRIPTION OF DRAWINGS

FIG. 1 is an explanatory view illustrating one example of the issuing-out operation within a warehouse.

FIG. 2 is an explanatory view illustrating the working area illustrated in FIG. 1 in detail.

FIG. 3 is an explanatory view illustrating the gates in detail.

FIG. 4A is an explanatory view illustrating one example of the picking system.

FIG. 4B is an explanatory view illustrating one example of the picking system.

FIG. 5 is a block diagram illustrating an example of the hardware configuration of a computer.

FIG. 6 is a block diagram illustrating an example of the hardware configuration of an auto carriage.

FIG. 7 is an explanatory view illustrating an example of the memory contents of a delivery destinations table.

FIG. 8 is an explanatory view illustrating an example of the memory contents of a delivery shelves table.

FIG. 9 is a sequence diagram illustrating a picking process procedure example by the picking system.

FIG. 10 is an explanatory view illustrating an example of making up order data.

FIG. 11 is a sequence diagram illustrating the detailed process procedure of the preprocessing (Step S904) illustrated in FIG. 9.

FIG. 12 is a flow chart illustrating the detailed process procedure example 1 of the selection process (Step S1101) illustrated in FIG. 11.

FIG. 13 is an explanatory view illustrating the segmentally collective shifting determination result in the delivery shelves table.

FIG. 14 is an explanatory view illustrating the list in which the segmentally collective shifting determination result illustrated in FIG. 13 is tabled.

FIG. 15 is a flow chart illustrating the detailed process procedure example 2 of the selection process (Step S1101) illustrated in FIG. 11.

FIG. 16 is an explanatory view illustrating the dispersion determination result in the delivery shelves stable.

FIG. 17 is an explanatory view illustrating the list in which the dispersion determination result illustrated in FIG. 16 is tabled.

FIG. 18 is a flow chart illustrating the detailed process procedure example of the shift-over determination process (Step S1104) illustrated in FIG. 11.

### DESCRIPTION OF EMBODIMENTS

<Example of Issuing-out Operation>

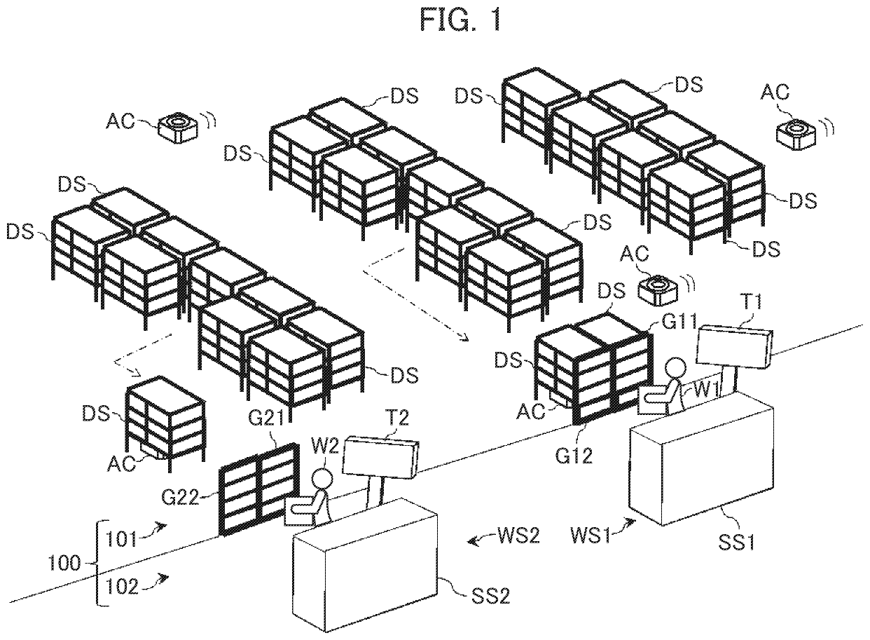

FIG. 1 is an explanatory view illustrating an example of the issuing-out-operation within a warehouse. The warehouse 100 includes a storage area 101 for articles and a working area 102. A plurality of delivery shelves DS is disposed within the storage area 101. One or more kinds of articles are stowed in each delivery shelf DS. Further, there exists a plurality of auto carriages AC within the storage area 101. The auto carriages AC move around under the control of a travel management device described at a later stage.

Specifically speaking, the auto carriage AC moves to a delivery shelf DS as designated. Upon the auto carriage AC moving right under the delivery shelf DS, it lifts the delivery shelf DS right above by a jacking mechanism provided on the upper surface of the auto carriage AC, but not illustrated in the drawing. Thereafter, the auto carriage AC moves to the working stations WS1 and WS2 as designated within the working area 102 with the delivery shelf DS carried thereon. For the sake of explanation, when the working stations WS1 and WS2 are not distinguished from each other, they are each described just as the working station. Upon the auto carriage AC arriving at the working station WS, it puts down the delivery shelf DS on the floor. Upon the issuing-out operation being over, the auto carriage AC lifts up the delivery shelf DS again so as to return the same to its original location.

There is a plurality of working stations WSi (in which ‘i’ is an integer satisfying the following expression: 1≤i≤, ‘n’ being an integer or 2 or larger, and denotes the total number of the working stations WS, ‘n’=2 in this example) within the working area 102. Each working station WSi includes gates Gij (in which ‘i’ is an integer satisfying the following expression: 1≤j≤m, ‘m’ being an integer or 2 or larger, and denotes the total number of the gates Gij per working station WSi, ‘m’=2 in this example), a terminal Ti and a sorting shelf SSi. The gates Gij become the points at which the delivery shelves DS arrives. Each gate Gij corresponds to each delivery shelf DS. The terminal Ti is a computer which displays information thereon or is manipulated by an operator Wi. The sorting shelf SSI is the shelf on which articles picked from the delivery shelf DS through the gate Gij are placed.

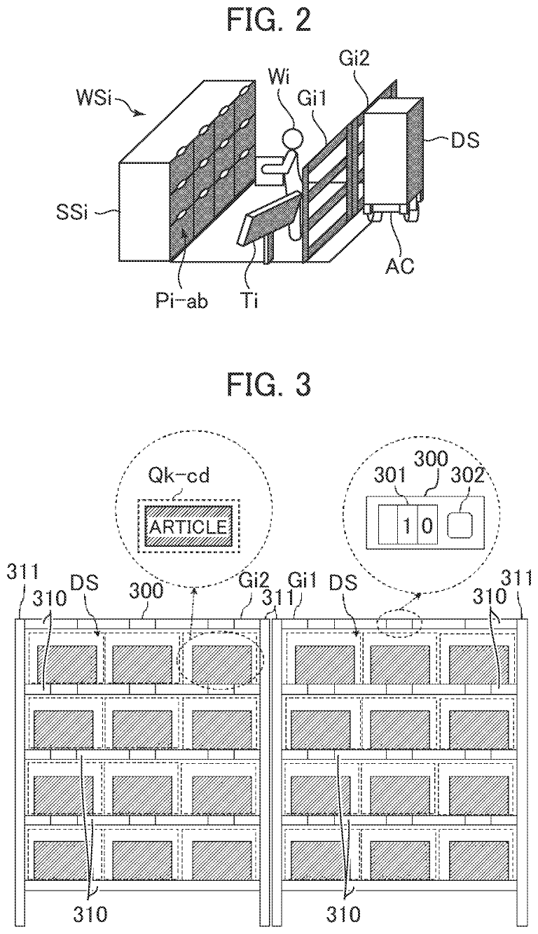

FIG. 2 is an explanatory view illustrating the working area 102 illustrated in FIG. 1 in detail. The sorting shelf SSi is provided with a plurality of sorting shelf segments Pi-ab (in which ‘a’ is an integer satisfying the following expression: 1≤a≤A, ‘A’ being an integer or 1 or larger, and denotes the segment stage of the sorting shelf SSi, ‘A’=3 in this example; and ‘b’ is an integer satisfying the following expression: 1≤b≤B, ‘B’ being an integer or 1 or larger, and denotes the segment row of the sorting shelf SSi, ‘B’=4 in this example). In other words, in this example, the sorting shelf SSi has twelve sorting shelf segments Pi-ab. Each sorting shelf segment Pi-ab corresponds to the delivery destination of the articles to be put into the each sorting shelf segment Pi-ab.

FIG. 3 is an explanatory view illustrating the gates Gij in detail. The gates Gij are each composed of horizontal bars 310 and vertical bars 311 supporting the horizontal bars 310 at both ends. The space between the horizontal bars 310 of the gates Gij respectively corresponds to the space between the placement plates of the delivery shelf DS. The delivery shelf DSk (′k′ is a number specifying a certain delivery shelf DS non-equivocally) divides the space between its placement plates into storage segments Qk-cd (in which ‘c’ is an integer satisfying the following expression: 1≤c≤C, ‘C’ being an integer or 1 or larger, and denotes the segment stage of the delivery shelf DS, ‘C’=4 in this example; and ‘d’ is an integer satisfying the following expression: 1≤d≤D, ‘D’ being an integer or 1 or larger, and denotes the segment row of the sorting shelf SSi, ‘D=3 in this example).

The gates Gij are each provided on the horizontal bars 310 with a display manipulation unit 300 corresponding to the storage segments Qk-cd. The display manipulation unit 300 is provided with a display section 301 and a manipulation section 302. The number of the articles to be picked from the corresponding storage segments Qk-cd and the number of the articles to be put into them are displayed on the display sections 301. The manipulation section 302 is a button manipulated by the operator Wi e.g. when the picking from the corresponding storage segments Qk-cd to the sorting shelf segment Pi-ab is over or when the putting-in to the corresponding storage segments Qk-cd is over.

At the issuing-out operation, for instance, when the delivery shelf DS standing by at the working station WS1 is required simultaneously at the working station WS2 as well, the idling time arises at the working station WS2. According to the present example, in order to reduce such idling time, as the preprocessing steps of the issuing-out operation, segmentally collective shifting, dispersion and shift-over of the articles among the delivery shelves DS are carried out, thereby, conflict on the delivery shelf DS between the first working station and the second working station and the transport of the delivery shelves DS wasteful in time and cost during the issuing-out operation being suppressed, so that the idling time on the part of the operator Wi engaged in the issuing-out operation can be reduced, which allows the efficiency with which the issuing-out operation is performed to be enhanced.

<Example of Picking System>

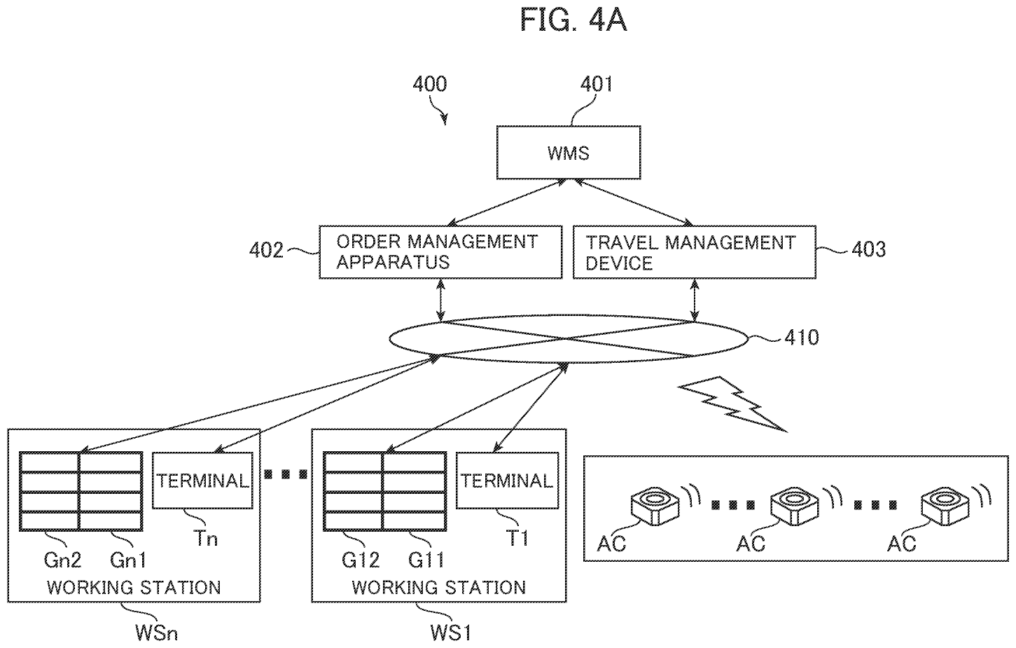

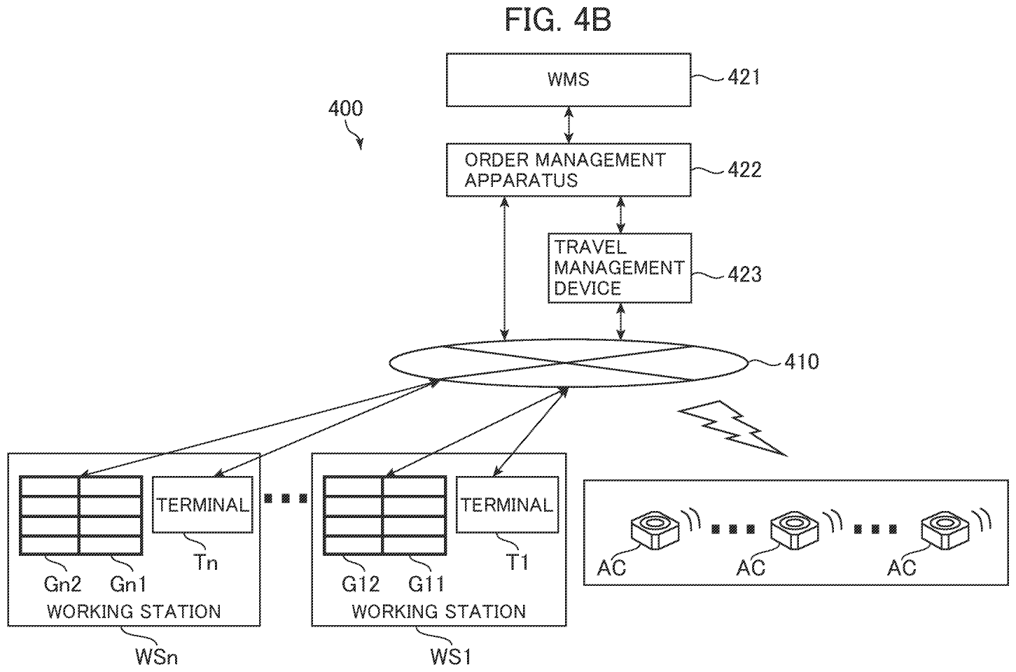

FIG. 4A is an explanatory view illustrating one example of the picking system. The picking system 400 is provided with a Warehouse Management System (WMS) 401; an order management apparatus 402; a travel management device 403; auto carriages AC, the terminal Ti and the gates Gij. The WMS 401 is connected in communication with the order management apparatus 402 and the travel management device 403. The order management apparatus 402, the travel management device 403, the auto carriages AC, the terminal Ti and the gates Gij are in communication with one another through a network 410. At least the auto carriages AC are connected in radio communication with the travel management device 403 through the network 410.

The WMS401 controls the order management apparatus 402 and the travel management device 403. Specifically speaking, the WMS401 transmits an order and delivery shelves data to the order management apparatus 402, in which the order is information including the names and the number of pieces of the articles and their delivery destinations and the delivery shelves data are those relating to the delivery shelves DSk in which the articles are stored. Specifically speaking, for instance, the delivery shelves data include the names and the number of pieces of the articles being stored, the delivery shelves DSk in which such articles are stored, and the locational information on the storage segments Qk-cd to which such articles are stored. The WMS401 acts as a liaison between the processing at the order management apparatus 402 and the processing at the travel management device 403. For instance, upon the WMS401 receiving from the order management apparatus 402 the notice to the effect that the issuing-out operation is over, it instructs the travel management device 403 to return the delivery shelves DSk to their original places.

According to the picking system embodied herein, the system is arranged such that the order management apparatus 402 and the travel management device 403 are connected in parallel with respect to the WMS401 as illustrated in FIG. 4A. Accordingly, pieces of information processed at the order management apparatus 402 or the travel management device 403 are transmitted and/or received through the WMS401 so as to be updated in the real-time basis. As an example of another system configuration, such hierarchical system may be designed that the WMS421 controls the order management apparatus 422 and the order management apparatus 422 controls the travel management device 423 as exemplified in FIG. 4B. Adopting the system configuration as illustrated in FIG. 4B allows the order management apparatus 422 and the travel management device 423 to directly exchange information between them without the intervention of the WMS421.

The order management apparatus 402 executes the reception processing to receive the order and the delivery shelves data from the WMS401 so as to generate order data. The order data are those to make the order correspond to the sorting shelf segments Pi-ab of the sorting shelves SSi. Further, the order management apparatus 402 receives the delivery shelves data from the WMS401 and stores such data in the delivery shelves data table described at a later stage. The order management apparatus 402 controls the gates Gij and the terminal Ti, the details of which are described at a later stage.

The travel management device 403 has coordinate information of the storage area 101 and manages information on the current location of each delivery shelf DS. The floor surface of the storage area 101 is divided into e.g. two-dimensional meshes and the travel management device 403 manages the coordinate values at the center of each mesh (not necessarily those at the center, but those at the apex of each mesh). Further, each mesh is provided with a marker including its coordinate values. The marker is a bar code (also including a two-dimensional code) adhered to or coated on each mesh. The bar code is information incorporating the coordinate values of each mesh.

Further, the travel management device 403 manages the travelling of the auto carriages AC. Specifically speaking, for instance, upon the travel management device 403 receiving the transport instruction of the delivery shelves DS from the order management apparatus 402 through the WMS401, it specifies the delivery shelf DS in which the articles to be delivered are stored and the working station in which there is the sorting shelf SSi having the sorting shelf segment Pi-ab to which the articles to be delivered are destined; calculates the travelling course information up to the specified working station WSi by way of the specified delivery shelf DS; and then transmits such travelling course information to a certain auto carriage AC, e.g. the auto carriage nearest to the specified delivery shelf DS so as to instruct the same to move according to such information.

The auto carriage AC scans the floor surface during travelling and acquires the coordinate values of each mesh by scanning the bar codes thereon upon passing each mesh. The auto carriage AC transmits the acquired coordinate values to the travelling management device 403, thereby, the current position of the auto carriage AC being managed. Further, the auto carriage AC may be travelled by sequentially estimating its own position by means of e.g. such measuring systems as sonar and a laser scanner provided thereon without depending upon the markers.

Further, the travel management device 403 determines whether or not the coordinate values on the current position of the auto carriage AC corresponds to the coordinate values of the mesh on which the delivery shelf DS to be transported is disposed. If in the affirmative, the travel management device 403 transmits the lift-up instruction information to the auto carriage AC. Upon the auto carriage AC receiving the lift-up instruction information, it lifts up the delivery shelf DS by means of its jacking mechanism; and then moves to the working station WSi corresponding to its target destination.

Moreover, the travel management device 403 determines whether or not the coordinate values on the current position of the auto carriage AC corresponds to the coordinate values of the mesh in front of the gate Gij designated anterior to the working station WSi corresponding to its target destination. If in the affirmative, the travel management device 403 transmits the lift-down instruction information to the auto carriage AC. Upon the auto carriage AC receiving the lift-down instruction information, it halts and puts down the delivery shelf DS on the floor surface by means of its jacking mechanism.

Furthermore, upon the travel management device 403 receiving information to the effect that the issuing-out operation from the delivery shelf DS is over from the order management apparatus 402 through the WMS401, it transmits the lift-up instruction information and the retreat instruction information to the auto carriage AC. Upon the auto carriage AC receiving the lift-up instruction information, it lifts up the delivery shelf DS again and upon receiving the retreat instruction information, it moves to the original place where the delivery shelf DS has been disposed with the delivery shelf DS carried thereon according to the traveling course information.

Then, the travel management device 403 determines whether or not the coordinate values on the current position of the auto carriage AC corresponds to the coordinate values of the mesh corresponding to the original place where the delivery shelf DS has been disposed. If in the affirmative, the travel management device 403 transmits the lift-down instruction information to the auto carriage AC. Upon the auto carriage AC receiving the lift-down instruction information, it puts down the delivery shelf DS on the floor surface. Then, the auto carriage AC deletes the travelling course information.

<Example of Hardware Configuration>

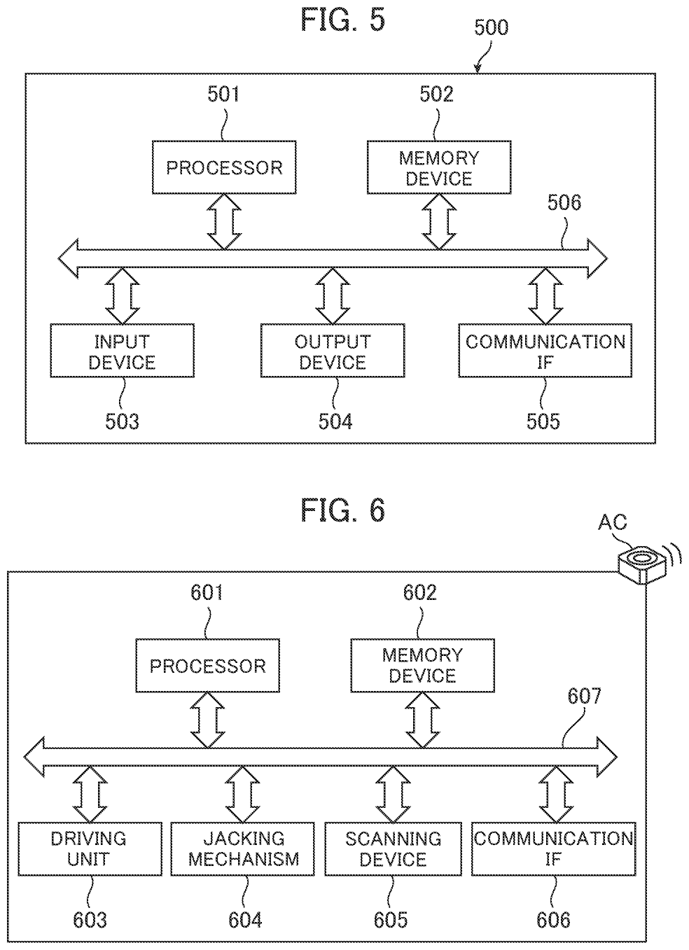

FIG. 5 is a block diagram illustrating an example of the hardware configuration of the WMS401, the order management apparatus 402, the travel management device 403 and the terminal Ti (hereinafter, simply referred to as computer 500). The computer 500 is provided with a processor 501, a memory device 502, an input device 503, an output device 504 and a communication interface (communication IF 505). The processor 501, the memory device 502, the input device 503, the output device 504 and the communication IF 505 are interconnected with one another by way of a bus 506.

The processor 501 controls the computer 500. The memory device 502 acts as the working area of the processor 501. Further, the memory device 502 is a non-temporary or temporary recording medium to store various types of programs and data. The memory device 502 includes ROM (Read Only Memory), RAM (Random Access Memory), HDD (Hard Disk Drive) and a flash memory, by way of some examples. The input device 503 inputs data. The input device 503 includes a keyboard, a mouse, a touch panel, a numeric keypad and a scanner, by way of some examples. The output device 504 outputs data. The output device 504 includes a display and a printer, by way of some examples. The communication IF 505 is in connection with the network 410 so as to transmit/receive data between them.

FIG. 6 is a block diagram illustrating an example of the hardware configuration of the auto carriage AC. The auto carriage AC is provided with a processor 601, a memory device 602, a driving unit 603, a jacking mechanism 604, a scanning device 605 and a communication IF 606. The processor 601, the memory device 602, the driving unit 603, the jacking mechanism 604, the scanning device 605 and the communication IF 606 are interconnected with one another byway of a bus 607. The processor 601 controls the auto carriage AC. The memory device 602 acts as the working area of the processor 601. Further, the memory device 602 is a non-temporary or temporary recording medium to store various types of programs and data. The memory device 602 includes ROM, RAM, HDD and a flash memory, by way of some examples.

The driving unit 603 moves, turns or halts the auto carriage AC under the control of the processor 601. The jacking mechanism 604 lifts up or jacks up the delivery shelf DS upon receiving the lift-up instruction information while descending the delivery shelf DS or jacks down upon receiving the lift-down instruction information under the control of the processor 601. The scanning device 605 scans the markers on the floor surface. In the case where the markers are bar codes, the scanning device 605 is a bar code reader. The communication IF 606 is in connection with the network 410 so as to transmit/receive data to/from the travel management device 403.

<Example of Memory Contents in Various Types of Tables>

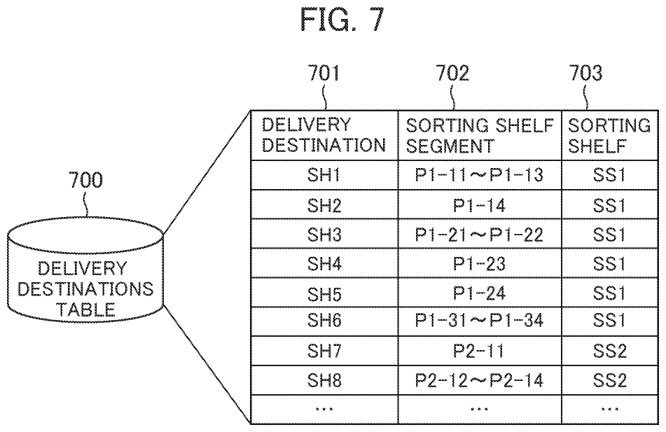

FIG. 7 is an explanatory view illustrating an example of the memory contents of the delivery destinations table. The delivery destinations table 700 includes pieces of information which the order management apparatus 402 stores. The delivery destinations table 700 is provided with a delivery destination field 701, a sorting shelf segment field 702 and a sorting shelf field 703. The delivery destination field 701 is a memory field to store information to specify delivery destination. The sorting shelf segment field 702 is a memory field to store the sorting shelf segments Pi-ab. The delivery destination corresponds to one or more sorting shelf segments Pi-ab. The sorting shelf field 703 is a memory field to store information to specify the sorting shelves SSi. With reference to the delivery destinations table 700, for instance, the entry at Line 1 or the delivery destination SH1 corresponds to the sorting shelf segments P1-11 to P1-13 within the sorting shelf SS1. In other words, the articles put into the sorting shelf segments P1-11 to P1-13 within the sorting shelf SS1 are delivered to the delivery destination SH1.

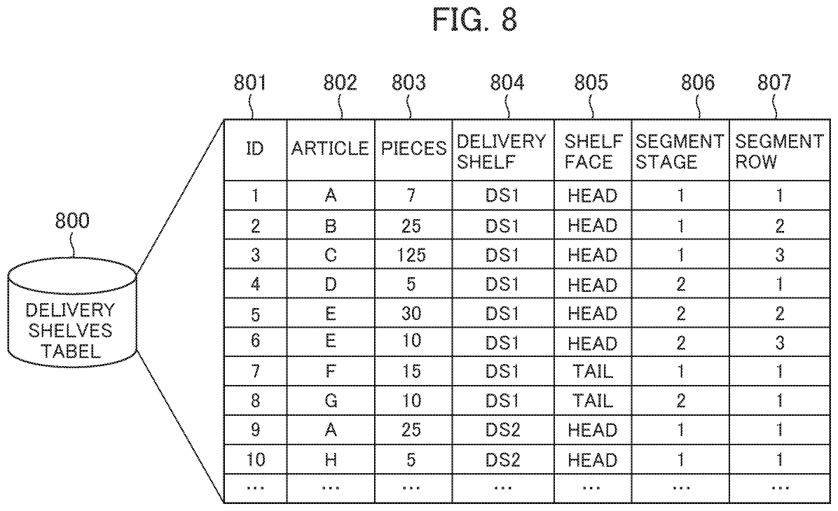

FIG. 8 is an explanatory view illustrating an example of the memory contents of the delivery shelves table. The delivery shelves table 800 includes data to store information on the delivery shelves DS. The delivery shelves table 800 is stored in the WMS401 and the order management apparatus 402 and is updated into the latest data in synchronization between them.

The delivery shelves table 800 is provided with an ID field 801, an article field 802, a field 803 for the number of pieces of articles, a delivery shelf field 804, a shelf face field 805, a segment stage field 806 and a segment row field 807. The delivery shelf data corresponding to the entry of the delivery shelves table 800 are made up by combining the values of the same line in which the respective fields 801 to 807 are lined up.

The ID field 801 is a memory field to store an ID to specify certain delivery shelf data in a non-equivocal manner in terms of value. The article field 802 is a memory field to store the name of the article or the denomination thereof in terms of value. The field 803 for the number of pieces of articles is a memory field to store the number of pieces of articles being stored and specified under their own names in terms of value. The delivery shelf field 804 is a memory field to store information to specify a delivery shelf DS in which the articles specified under their own names are being stored in terms of value.

The shelf face field 805 is a memory field to store the shelf face of the delivery shelf DS in terms of value, in which the shelf face, for instance, means that the frontal side of the delivery shelf DS is ‘head’ while the backside thereof is ‘tail’. To note, in the case where the delivery shelf DS is transported to the gate Gij by the auto carriage AC, the side of the delivery shelf facing the gate Gij corresponds to ‘head’. The segment stage field 806 is a memory field to store a segment stage of the delivery shelf DS in terms of value. The segment stage is information to indicate that the storage segment Qk-cd is at the c-stage of the delivery shelf DSk. The segment row field 807 is a memory field to store the segment row of the delivery shelf DS. The segment row is information to indicate that the storage segment Qk-cd is at the d-row of the delivery shelf DSk.

For instance, with the delivery shelf data corresponding to the entry in which the ID is ‘1’, it shows that the article A, the number of pieces of which is 7, is stored in the storage segment Q1-11 positioned at the first stage and at the first row viewed from the shelf face ‘head’ of the delivery shelf DS1.

<Picking Sequence>

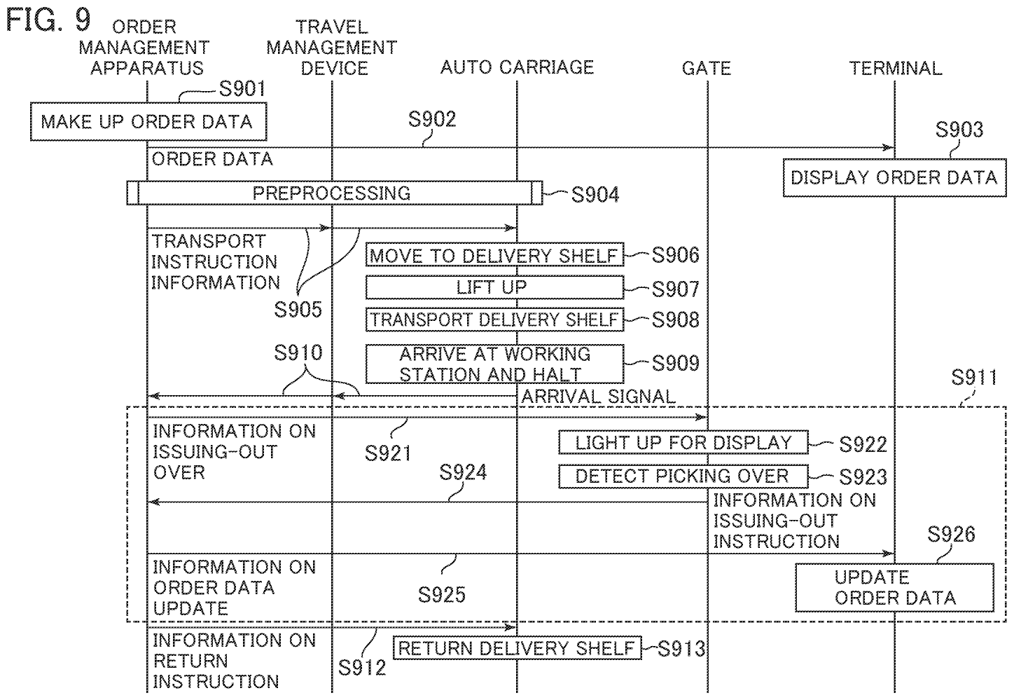

FIG. 9 is a sequence diagram illustrating a picking process procedure example by the picking system 400. In FIG. 9, in order to avoid redundancy of the explanation, the processing on the part of the WMS401 is omitted. To begin with, the order management apparatus 402 receives an order from the WMS401 so as to make up order data (at Step S901). An example of making up order data is explained in a concrete manner as follows.

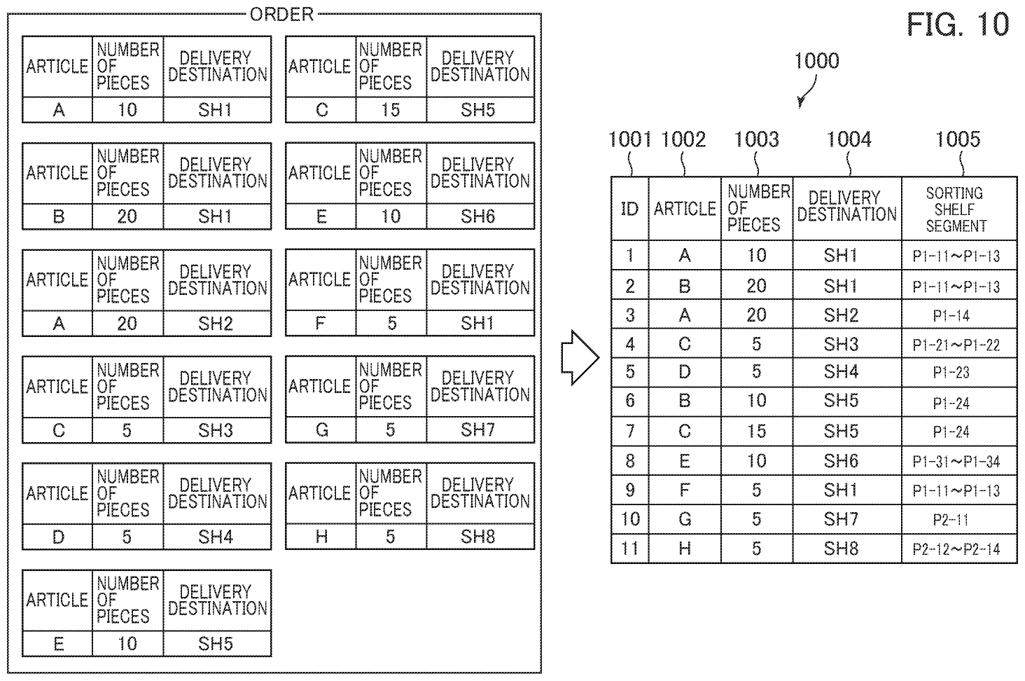

FIG. 10 is an explanatory view illustrating an example of making up order data. The order is information including the names and number of pieces of articles in order and their destination. The order data are pieces of information associating the order with the sorting shelf segments Pi-ab of the sorting shelf SSi corresponding to the delivery destinations of such order. The order management apparatus 402, with reference to the delivery destinations table 700, specifies the sorting shelf segments Pi-ab corresponding to the delivery destinations each and every order so as to associate such segments with such order, thereby, the order data being made up. Then, the order management apparatus 402 assigns an ID inherent in each piece of order data so as to make up an order data table 1000.

The order data table 1000 is provided with an ID field 1001, an article field 1002, a field 1003 for the number of pieces of articles, a delivery destination field 1004 and a sorting shelf segment field 1005. The order data corresponding to the entry of the order data table 1000 are made up by combining the values of the same line in which the respective fields 1001 to 1005 are lined up.

Returning to the illustration of FIG. 9, the order management apparatus 402 transmits a group of order data to the corresponding terminal Ti (at Step S902). Specifically speaking, for instance, the order management apparatus 402, with reference to the sorting shelf segments Pi-ab which are the values of the sorting shelf segment field 1005 of the order data table 1000, specifies the terminal Ti within the working station WSi in which the sorting shelf SSi of such segments is disposed and transmits a group of order data to such terminal Ti. By way of one example, according to the example illustrated in FIG. 10, a group of order data, the IDs of which are ‘1’ to ‘9’, is transmitted to the terminal Ti within the working station WS1. A group of order data, the IDs of which are ‘10’ and ‘11’, is transmitted to the terminal Ti within the working station WS2. Then, the terminals Ti which have received the respective groups of order data display the order data as received (at Step S903).

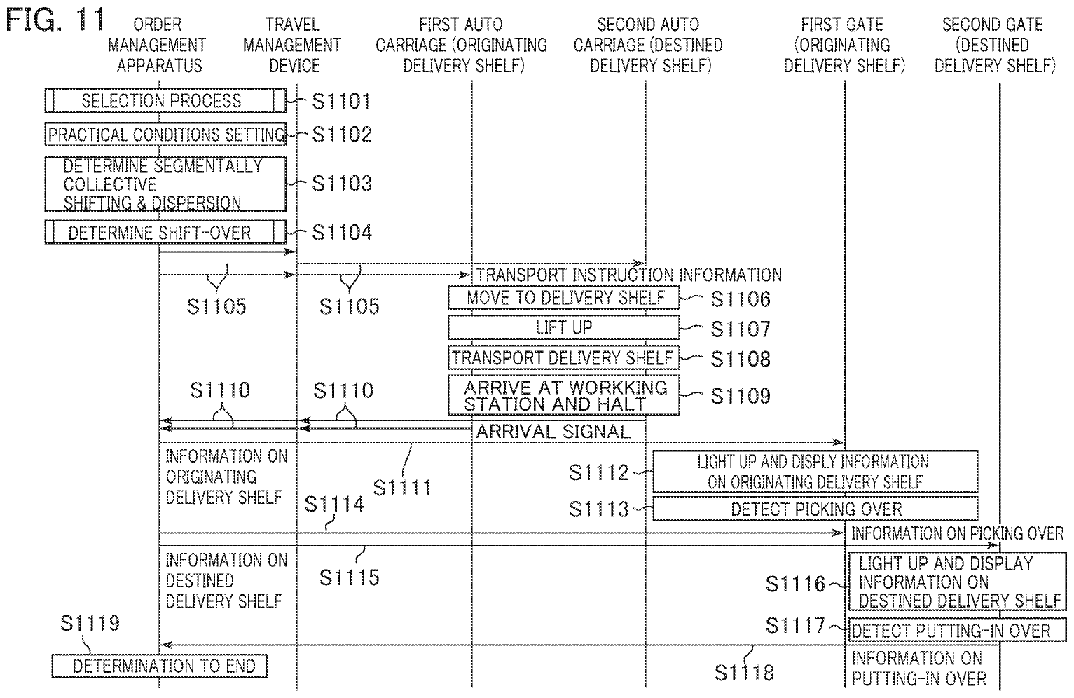

The order management apparatus 402 executes preprocessing (at Step S904) after having transmitted the respective groups of order data (at Step S902). The preprocessing (at Step S904) is such that segmentally collective shifting, dispersion and shift-over of the articles are executed among the delivery shelves DS before the picking process taken at and subsequent to the step S905. To note, all the segmentally collective shifting, dispersion and shift-over of the articles are not necessarily executed, but at least one of them may be executed. The detail of the preprocessing (taken at Step S904) is described at a later stage with reference to FIG. 11.

The order management apparatus 402 transmits the transport instruction information to the travel management device 403 through the WMS401 (at Step S905) after having completed the preprocessing (at Step S904). The transport instruction information is transferred from the travel management device 403 to the specific auto carriage AC that transports the delivery shelf DS to be transported in which the articles included in the order data are carried. The transport instruction information is information including the delivery shelf DS to be transported, the working station WSi to which such articles are delivered, the gate Gij at which the auto carriage arrives and the travelling course information for the auto carriage from the current position thereof by way of the delivery shelf DS to be transported up to the gate Gij.

Upon the auto carriage AC receiving the transport instruction information, it moves to the delivery shelf DS to be transported (at Step S906). The auto carriage AC moves under the delivery shelf DS and lifts up the same by means of its jacking mechanism 604 so as to make the same spaced apart from the floor surface (at Step S907). The auto carriage AC with the delivery shelf DS carried thereon moves in front of the gate Gij of the working station to which the articles are delivered (at Step S908). Upon the auto carriage AC arriving in front of the gate Gij, it halts and puts down the delivery shelf DS on the floor surface by means of its jacking mechanism 604 (at Step S909). Upon the auto carriage AC putting down the delivery shelf DS, it transmits an arrival signal to the travel management device 403 (at Step S910). The arrival signal is transferred from the travel management device 403 through the WMS401 to the order management apparatus 402. The arrival signal includes the identification information on the delivery shelf DS and the identification information on the gate Gij at which such delivery shelf DS has arrived.

Thereafter, the order management apparatus 402, the gate Gij and the terminal Ti execute the issuing-out assist process (at Step S911). The issuing-out assist process (at Step S911) is a process to assist an operator Wi present in the working station WSi in the issuing-out operation. The issuing-out assist process (at Step S911) is carried out in the numerical order of IDs which are the values of the ID field 1001 of the order data table 1000, by way of one example.

At the issuing-out assist process (at Step S911), upon the order management apparatus 402 receiving the arrival signal, it transmits the issue-out instruction information to the gate Gij at which the delivery shelf DS has arrived (at Step S921). The issue-out instruction information includes the identification information on the addressee's gate Gij, the target articles to be issued out and the number of their pieces and the locational information (shelf face, segment stage and segment row) of the target articles to be issued out at the transported delivery shelf DS. The identification information on the addressee's gate Gij is obtained from the arrival signal. The target articles to be issued out and the number of their pieces are obtained from the order data table 1000. The locational information of the target articles to be issued out at the transported delivery shelf DS is obtained from the delivery shelves table 800 by making use of the target articles to be issued out and the identification information on the delivery shelf DS both included in the arrival signal.

Upon the gate Gij receiving the issue-out instruction information, it lights up the display manipulation units 300 corresponding to the locational information included in the issue-out instruction information and the number of pieces of the target article to be issued out is displayed at the display manipulation units 300 (at Step S922).

The operator Wi takes out the target article to be issued out from the storage segment Qk-cd of the delivery shelf DS by its number of pieces as displayed byway of the lighted-up gate Gij. The operator Wi, with reference to the terminal Ti, grasps the delivery destinations of the target articles to be issued out and picked from such storage segment and stores them into the corresponding shelf segments Pi-ab of the sorting shelf SSi. Then, the operator Wi manipulates the display manipulation units 300 so as to turn them off.

As another method of recognizing the sorting shelf segments Pi-ab of the sorting shelf SSi corresponding to the target article to be issued out which are being sorted out by the operator Wi, the provision of the same display means as the gate Gij on the sorting shelf SSi is exemplified. For the target article to be issued out and picked from the storage segment Qk-cd of the delivery shelf DS, by lighting up the sorting shelf segments Pi-ab into which such article is sorted in the same way as the display manipulation sections 300, it allows the operator Wi to store the target article to be issued out while accurately grasping the number of pieces of such article to be stored by the same display method as the display units 301.

Upon the gate Gij detecting that the lights are turned off by the operator, it detects that the picking of the target article to be issued out is over (at Step S923). Then, the gate Gij transmits information to the effect that the issuing-out operation is over to the order management apparatus 402 (at Step S924).

Upon the order management apparatus 402 receiving the information to the effect that the issuing-out operation is over, it transmits a piece of order data update information to the terminal Ti (at Step S925). The order data update information includes the ID of the order data on the article whose picking is over and an ID of order data covering the article to be subsequently picked.

Upon the terminal Ti receiving the order data update information, it updates order data by making use of an ID included in the order data update information (at Step S926). Specifically speaking, the terminal Ti deletes the order data on the article whose picking is over from the groups of order data and then displays with highlights order data covering the article to be subsequently picked, thereby, the issuing-out assist process (at Step S911) on one of the target articles to be issued out ends. The issuing-out assist process (at Step S911) is executed for the entire articles included in the transported delivery shelf DS among those listed in the whole entries of the order data table 1000 managed by the order management apparatus 402.

When the issuing-out assist process (at Step S926) on the transported delivery shelve DS is over, the order management apparatus 402 transmits the return instruction information of the delivery shelve DS to the travel management device 403 by way of the WMS401 (at Step S912). The return instruction information is transferred by the travel management device 403 to the auto carriage AC standing by right under the delivery shelve DS in front of the gate Gij of the working station.

Upon the auto carriage AC receiving the return instruction information, it returns the delivery shelf DS to its original place (at Step S913). Specifically speaking, the auto carriage AC lifts up the delivery shelf DS by means of its jacking mechanism 604 so as to make the same spaced apart from the floor surface. The auto carriage AC transports the delivery shelf DS to its original place with the delivery shelf DS carried thereon. Upon the auto carriage arriving at the original place of the delivery shelf, it halts and puts the same down on the floor surface by means of its jacking mechanism 604. Upon the auto carriage AC putting down the delivery shelf DS, it transmits the arrival signal to the travel management device 403. When the other delivery shelves DS are transported to the working station WSi, the steps at and subsequent to S905 are repeated.

<Preprocessing (Step S904)>

FIG. 11 is a sequence diagram illustrating the detailed process procedure example of the preprocessing (at Step S904) illustrated in FIG. 9. The order management apparatus 402 executes the selection process (at Step S1101). The selection process (at Step S1101) is a process to select articles candidates to be segmentally collectively shifted and those candidates to be dispersed each and every kind of article. Through the selection process (at Step S1101), groups of articles stored in the delivery shelf DS are classified into the target articles candidates to be segmentally collectively shifted, those to be dispersed and those other than such candidates each and every kind of article. The detail of the selection process (at Step S1101) is described at a later stage.

Then, the order management apparatus 402 carries out the setting of practical conditions (at Step S1102). What is referred to as practical conditions herein denotes conditions to scrutinize the target articles to be segmentally collectively shifted and those to be dispersed which are selected at the selection process (at Step S1101) and to narrow down to those with priority.

By way of one example, the practical conditions for the segmentally collective shifting include the designation of the times of the segmentally collective shifting operations and the time in which such operation proceeds in order to make the duration of such operations as short as possible. The times of such operations are converted into time based on the prescribed duration per operation and the past accumulated data. Then, the order management apparatus 402 scrutinizes the whole target articles candidates to be segmentally collectively shifted and narrows down to those whose number of pieces to be issued out are larger or which have a larger number of storage segments of the delivery shelf DS with priority such that the designated times of such segmentally collective shifting operations and time limit in which such operation proceeds are satisfied.

Further, the practical condition for segmentally collective shifting may be such that such segmentally collective shifting is practiced when the number of the empty storage segments Qk-cd of the entire delivery shelves DSk is equal to or smaller than the prescribed number, thereby, the number of the empty storage segments Qk-cd can be relatively incremented. Further, such practical condition may be such that segmentally collective shifting is not practiced where the maximum number of the target articles candidates to be segmentally collectively shifted is larger than the number of the target articles candidates to be segmentally collectively shifted which are issued out, thereby, the segmentally collective shifting wasteful in time and cost being suppressed.

By way of one example, the practical condition for dispersion includes such limitation as how far the entire delivery shelves DS in which articles are stored being allocated for the delivery shelves DS used for the issuing-out operation. In this case, the number of the storage segments of the usable delivery shelves DS is regulated. For instance, the order management apparatus 402 scrutinizes the whole target article candidates to be dispersed and narrows down to those whose number of pieces to be issued out are larger or which have a larger number of the sorting shelf segments of the sorting shelf SSi with priority such that the regulated number of the storage segments is not exceeded, thereby, the dispersion operation wasteful in time and cost being suppressed with the number of the storage segments usable for dispersion regulated. To note, the setting of the practical conditions (at Step S1102) is optional, so that the order management apparatus 402 not necessarily executes the setting of such conditions (at Step S1102).

The order management apparatus 402 (at Step S1103) determines the target articles to be segmentally collectively shifted from the target articles candidates to be segmentally collectively shifted and the target articles to be dispersed from the target article candidates to be dispersed according to the setting of the practical conditions (at Step S1102). In the case where the setting of such conditions (at Step S1102) is not executed, the target articles candidates to be segmentally collectively shifted become the target articles to be segmentally collectively shifted while the target articles candidates to be dispersed become the target articles to be dispersed.

The order management apparatus 402 executes the shift-over determination process on the target articles to be segmentally collectively shifted and those to be dispersed (at Step S1104). The shift-over determination process (at Step S1104) is a process to determine that the articles stored in a certain storage segment Qk-cd of a certain delivery shelf DSk are shifted over from such storage segment Qk-cd to the storage segment Qh-cd of another delivery shelf DSh (h≠k). For example, where the articles A and B whose types of order groups are different from each other are dispersed to the plurality of delivery shelves DSx and DSy, it requires that the respective delivery shelves DSx and DSy be called for by the same working station WSi. Accordingly, the order management apparatus 402 determines that the article A is shifted over from the delivery shelf DSx to the storage segment Qy-cd of the delivery shelf DSy, thereby, just calling for the delivery shelf DSy to such working station permitting the articles A and B to be picked.

Further, in the case where the articles A and B whose types of order groups are different from each other are stored in the same delivery shelf DSx and such delivery shelf is called for by the plurality of working stations WS1 and WS2, there is likelihood that the conflict on the delivery shelf DSx between such working stations WS1 and WS2 might arise. More specifically, there is possibility that the issuing-out operation of the article A at the one working station WS1 and that of the article B at the other working station WS2 might arise at the same time. Such situation occurs when the number of orders for the articles A and B respectively is more than the prescribed number. Thus, the order management apparatus 402 determines that the article A is shifted over from the delivery shelf DSx to the storage segment Qy-cd of another delivery shelf DSy, thereby, the conflict on the delivery shelf DSx regarding the articles A and B between such stations being suppressed.

To note, the shift-over determination process (at Step S1104) is executed for the target articles to be segmentally collectively shifted and those to be dispersed, but it may be executed only for the target articles to be segmentally collectively shifted or only for those to be dispersed. Moreover, such shift-over determination process may be executed on the articles other than those to be segmentally collectively shifted and those to be dispersed among those included in order groups or may be executed on the entire articles included in order groups.

The steps at and subsequent to the Step S1105 are executed for non-selected target articles to be segmentally collectively shifted, non-selected target articles to be dispersed and non-selected target articles to be shifted over respectively.

The order management apparatus 402 transmits through the WMS401 the transport instruction information to the travel management device 403 in order to transport the delivery shelves DS to store the target articles to be segmentally collectively shifted and those to be dispersed or those to be shifted over (at Step S1105). The transport instruction information is transferred to the first auto carriage AC to transport the first delivery shelf DS corresponding to the delivery shelf from which the target articles to be segmentally collectively shifted and those to be dispersed or those to be shifted over are derived (hereinafter, referred to as originating delivery shelf) and to the second delivery cart AC to transport the second delivery shelf DS corresponding to the delivery shelf to which the target articles to be segmentally collectively shifted and those to be dispersed or those to be shifted over are destined (hereinafter, referred to as destined delivery shelf) respectively.

The transport instruction information hereof is information including the delivery shelves DS to be transported, the working station WSi to which such target articles are transported, the gates Gij at which the auto carriages arrive and the travelling course information from the current locations of the auto carriages via the delivery shelves DS to be transported to the gates Gij at which the auto carriages arrive. To note, it is arranged such that the gate Gij at which the first auto carriage AC arrives and the gate Gij at which the second auto carriage AC arrives are adjoining to each other at the same working station WSi.

Upon the first and second auto carriages AC receiving the transport instruction information, those carriages which have received such information moves to the first delivery shelf DS and the second delivery shelf DS respectively (at Step S1106). The first and second auto carriages DS respectively move under the corresponding first and second delivery shelves DS and lift up such corresponding shelves by means of their jacking mechanism 604 so as to make such shelves spaced apart from the floor surface (at Step S1107). The first and second auto carriages AC move in front of the corresponding first and second gates Gij of the same working station to which the delivery shelves are destined with such shelves carried thereon (at Step S1108).

Upon the first and second auto carriages AC arriving in front of the corresponding first and second gates Gij, they halt and put down the corresponding first and second delivery shelves DS on the floor surface by means of their jacking mechanism 604 (at Step S1109). Upon the first and second auto carriages AC putting down the corresponding first and second delivery shelves DS, they transmit the arrival signal to the travel management device 403 (at Step S1110). The arrival signal is transferred from the travel management device 403 through the WMS401 to the order management apparatus 402. The arrival signal includes the identification information of the first and second delivery shelves DS respectively and the identification information of the first and second gates Gij respectively at which the first and second delivery shelves DS have arrived.

Upon the order management apparatus 402 receiving the arrival signal, it transmits information on the originating delivery shelf to the first gate at which the first delivery shelf DS has arrived (at Step S1111). The information on the originating delivery shelf includes the identification information of the first gate Gij, information on the target articles to be picked (those to be segmentally collectively shifted, those to be dispersed or those to be shifted over) and the number of pieces of such target articles and the locational information (shelf face, segment stage and segment row) of the target articles to be picked at the first delivery shelf DS which has arrived at the first gate. The identification information of the first gate Gij is obtained from the arrival signal. The target articles to be picked and the number of pieces of such target articles are obtained from data on the target articles to be picked described at a later stage. The locational information (shelf face, segment stage, and segment row) of the target articles to be picked at the first delivery shelf DS which has arrived at the first gate is obtained from the data on the target articles to be picked by making use of the identification information of the first delivery shelf DS included in the arrival signal. The data on the target articles to be picked are data obtained through the steps S1101 to S1104 from the delivery shelves table 800.

Upon the first gate Gij receiving the information on the originating delivery shelf, it lights up the display manipulation units 300 corresponding to the locational information included in the information on the originating delivery shelf and displays the number of pieces of the target articles to be picked at such display manipulation units 300 (at step S1112).

The operator Wi takes out the target articles to be picked from the storage segments Qk-cd of the first delivery shelf DSk corresponding to the first gate Gij, the display manipulation units of which are being lighted up, by the number of pieces displayed on such units. The operator Wi manipulates the lighted-up display manipulation units 300 so as to turn them off. Upon the first gate Gij detecting that such units are turned off by the operator, it detects that the picking of the target articles to be picked is over (at Step S1113). Then, the first gate Gij transmits information to the effect that the picking is over to the order management apparatus 402 (at Step S1114).

Upon the order management apparatus 402 receiving the information to the effect that the picking is over, it transmits information on the destined delivery shelf to the second gate Gij (at Step S1115). The information on the destined delivery shelf includes the identification information of the second gate Gij, information on the picked target articles and the number of such picked target articles and the information (shelf face, segment stage, and segment row) on the locations at the destined delivery shelf or the second delivery shelf DS to which the picked target articles are destined. The identification information of the second gate Gij is obtained from the arrival signal. The picked target articles and the number of pieces of such picked target articles are obtained from data on the picked target articles described at a later stage. The information on the locations at the destined delivery shelf or the second delivery shelf DS to which the picked target articles are destined is obtained from the data on the picked target articles by making use of the identification information of the second delivery shelf DS included in the arrival signal.

The operator Wi puts the picked target articles into the storage segments Qk-cd of the second delivery shelf DS corresponding to the lighted-up second gate Gij by the number of pieces displayed on such display units. The operator Wi manipulates the lighted-up display manipulation units 300 so as to turn them off. Upon the second gate Gij detecting that such units are turned off by the operator, it detects that the putting-in of the picked target articles is over (at Step S1117). Then, the second gate Gij transmits information to the effect that the putting-in is over to the order management apparatus 402 (at Step S1118).

The order management apparatus 402 executes determination to end (at Step S1119). The determination to end (at Step S1119) is a process to determine whether or not non-selected target articles to be picked remain. If in the affirmative, the processes at and subsequent to Step S1105 are resumed.

<Selection Process (Step S1101>

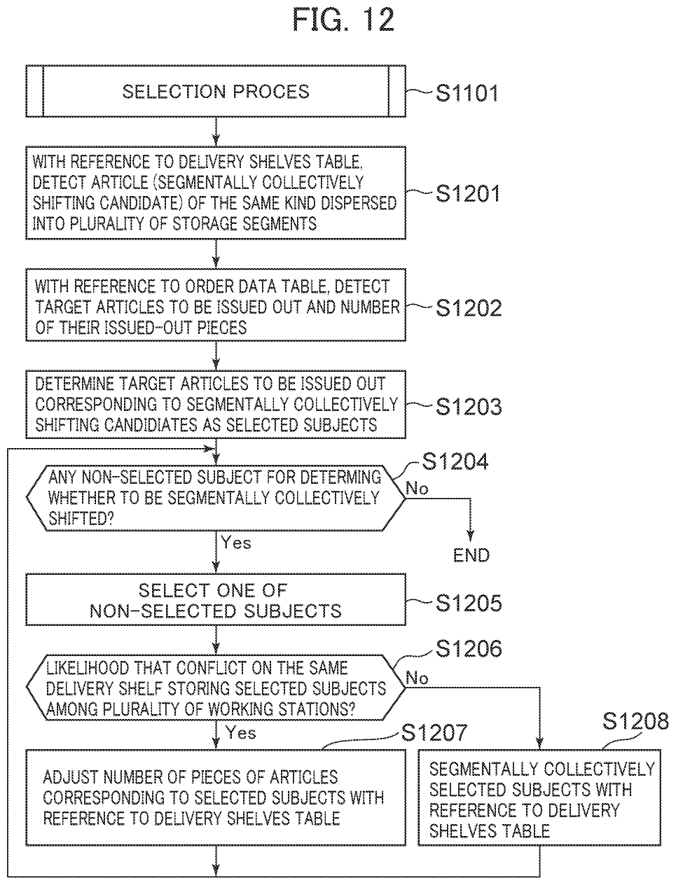

FIG. 12 is a flow chart illustrating the detailed process procedure example 1 of the selection process (Step S1101) illustrated in FIG. 11. The flow chart illustrated in FIG. 12 is intended for selecting the target articles to be segmentally collectively shifted. The order management apparatus 402, with reference to the delivery shelves table 800, detects the same kinds of articles dispersed over the plurality of storage segments Qk-cd as the target articles to be segmentally collectively shifted (at Step S1201). The plurality of storage segments Qk-cd in which such target articles to be segmentally collectively shifted are stored may be of the same delivery shelf DS or of different delivery shelves DS.

More specifically, for example, with reference to FIG. 8, the article corresponding to the ID entry number ‘1’ is ‘A’, the storage segment Qk-cd of which is specified with the delivery shelf ‘DS1’, the shelf face ‘head’, the segment stage ‘1’ and the segment row ‘1’. Further, the article corresponding to the ID entry number ‘9’ is ‘A’, the storage segment Qk-cd of which is specified with the delivery shelf ‘DS2’, the shelf face ‘head’, the segment stage ‘1’ and the segment row ‘1’. Accordingly, the article ‘A’ indicated by the ID entry numbers ‘1’ and ‘9’ corresponds to a target article candidate to be segmentally collectively shifted.

Further, with reference to FIG. 8, the article corresponding to the ID entry number ‘5’ is ‘E’, the storage segment Qk-cd of which is specified with the delivery shelf ‘DS1’, the shelf face ‘head’, the segment stage ‘2’ and the segment row ‘2’. Further, the article corresponding to the ID entry number ‘6’ is ‘E’, the storage segment Qk-cd of which is specified with the delivery shelf ‘DS1’, the shelf face ‘head’, the segment stage ‘2’ and the segment row ‘3’. Accordingly, the article ‘E’ indicated in the ID entry numbers ‘5’ and ‘6’ corresponds to a target article candidate to be segmentally collectively shifted.

To note, when the shipping request from the delivery destination is not completed on time or there is no shipping request, the order management apparatus 402 may add such articles as having been sequentially and frequently subjected to shipping requests to the target article candidates to be segmentally collectively shifted based on the past shipping data.

The order management apparatus 402, with reference to the order data table 1000 illustrated in FIG. 10, detects the target articles to be issued out and the number of the pieces of such issued-out target articles (at Step S1202).

The order management apparatus 402 defines the target articles to be issued out corresponding to the target articles candidates to be segmentally collectively shifted as subjects for determining whether or not they are to be segmentally collectively shifted (at Step S1203). More specifically, for instance, the order management apparatus 402 defines the target articles candidates to be segmentally collectively shifted as well as the target articles to be issued out as the subjects for determining whether or not they are to be segmentally collectively shifted. According to the above example, the articles A and E are detected as the target articles candidates to be segmentally collectively shifted at Step S1201 and the articles A to H are detected at Step S1202. Thus, the order management apparatus 402 determines the articles A and E as such subjects.

The order management apparatus 402 determines whether or not there are non-selected subjects for determining whether or not they are to be segmentally collectively shifted (at Step S1204). If in the affirmative (at Step S1204: Yes), the order management apparatus 402 selects one of such subjects (at Step S1205).

The order management apparatus 402 determines whether or not there is likelihood that the conflict on the same delivery shelf DS having selected subjects for determining whether or not they are to be segmentally collectively shifted might occur among the plurality of working stations (at Step S1206). The determination process at Step S1206 is more specifically explained as follows.

When the article dispersed over the plurality of storage segments Qk-cd is segmentally collectively shifted to segments smaller in number, for instance, when it is segmentally collectively shifted to one storage segment Qk-cd, the number of articles to be stored and their kinds increase with the filling rate of the articles in the delivery shelf DS enhanced. On the other hand, for instance, there is possibility that a certain segmentally collectively shifted article A might be required over a number of issue-out destinations or over the plurality of working stations WS1 and WS2 or the article A might be called for by the plurality working stations WS1 and WS2 at the same period of time. In this case, the delivery shelf DS1 in which such certain article A is stowed is transported to the next working station WS2 after completing the issuing-out operation at the working station WS1 at which it has first arrived.

Thus, the delivery shelf DS1 in which such certain article A is stowed is put to use for the issuing-out operation at the working station WS1 at which it has first arrived. In the meantime, at the next working station WS2, the idling time on the part of the operator Wi there occurs. In order to overcome the idling time on the part of the operator Wi at the working station WS2, the order management apparatus 402 executes the step S1206 on such selected subjects. In other words, the step S1206 is a process to determine whether or not such selected subjects are called for by the plurality of working stations at the same period of time.

In this regard, the case in which such selected subjects for determining whether or not they are to be segmentally collectively shifted are called for by the plurality of working stations at the same time denotes e.g. that where while the specific delivery shelf DS to store the target article to be issued out is transported to the working station WS1 and the issuing-out operation of such target article is over, the instruction to perform such issuing-out operation for such article from the specific delivery shelf arises at the working station WS2.

More specifically, for example, it is assumed that the number of working stations operated during the issuing-out operation at a certain time span (e.g. one day) is defined as NP and the number of sorting shelf segments of the sorting shelf SSi assigned to one working station is defined as np. The number of the maximum sorting shelf segments assigned at the same period of time results in NP×np. It is assumed that the total number of the sorting shelf segments Pi-ab allocated to the entire delivery destinations during the issuing-out operation at a certain time span (e.g. one day) is defined as x and the total number of sorting shelf segments which are allocated to the entire delivery destinations from which a certain article (e.g. article A) corresponding to such selected subject is issued out during the issuing-out operation is defined as y.

The NP results in the number of kinds to represent the values of the sorting shelf field 703 of the delivery destinations table 700 corresponding to the values of the sorting shelf segment field 1005 of the order data table 1000 illustrated in FIG. 10. According to the example illustrated in FIG. 10, the sorting shelves SS1 and SS2 are those SSi within the corresponding working stations WS1 and WS2, so that the NP becomes ‘2’. The np is a fixed value and is stored in the memory device 502 of the order management apparatus 402. In this example, the np amounts to ‘12’.

Further, the x results in being the number of kinds to represent the values of the sorting shelf segment field 1005 of the order data table 1000 illustrated in FIG. 10. According to the example illustrated in FIG. 10, the values of the sorting shelf segment field 1005 amount to ‘16’ which is the total sum of P1-11 to P1-14, P1-21 to P1-24, P1-31 to P1-34 and P2-11 to P2-14.

The value of y is obtained from the delivery destinations field 1004 of the order data table 1000 illustrated in FIG. 10. For instance, in the case where such selected subject is the article A, its delivery destinations correspond to two or SH1 and SH2. There are three sorting shelf segments in number (P1-11 to P1-13) for the delivery destination SH1 and there is one sorting shelf segment in number (P1-14) for the delivery destination SH2, so that the value of y regarding the article A amounts to ‘4’.

To note, the value of y being obtained, the proportion of the articles which are not such selected subjects may be taken into account during the issuing-out operation each and every delivery destination. For instance, according to the above example, there are three sorting shelf segments in number allotted for the delivery destination SH1 of the article A, but the articles B and F other than the article A are delivered to the delivery destination SH1 as well during the issuing-out operation this time (see FIG. 10). In this case, because the number of the sorting shelf segments allotted to the delivery destination SH1 of the article A is reduced by one third, such number amounts to ‘1’. There is one sorting shelf segment (P1-14) for the delivery destination SH2. Accordingly, the value of y regarding the article A amounts to ‘2’.

Further, the quantity of each article may be taken into account. For instance, according to the above example, there are 10 pieces of the article A; there are twenty pieces of the article B; and five pieces of the article F all for the delivery destination SH1. In this case, the number of the sorting shelf segments allotted to the delivery destination SH1 of the article A results in being 10:35 in proportional ratio, so that such number amounts to 0.9 (the second and subsequent decimal places rounded up). There is one sorting shelf segment (P1-14) for the delivery destination SH2. Accordingly, the value of y regarding the article A amounts to ‘1.9’.

Moreover, the value of y being obtained, the volume of each article may be taken into account. For instance, according to the above example, there are ten pieces of the article A; there are twenty pieces of the article B; and there are five pieces of the article Fall for the delivery destination SH1. Now, it is assumed that proportional ratio in volume among the articles A, B and F is 1:2:3. In this case, the number of the sorting shelf segments allotted to the delivery destination SH1 of the article A results in being 10:65 in proportional ratio, so that such number amounts to 0.5 (the second and subsequent decimal places rounded up). There is one sorting shelf segment (P1-14) for the delivery destination SH2. Thus, the value of y regarding the article A amounts to ‘1.5’.

In this way, taking into account the number of kinds of articles delivered to the delivery destination during the issuing-out operation allows the proportional ratio of the sorting shelf segments allotted to the delivery destination of the selected subject for determining whether or not it is to be segmentally collectively shifted to be specified, so that the value of y can be obtained with high precision.

Further, taking into account the quantity of each article allows the proportion of the sorting shelf segments allotted to the delivery destination of such selected subject to be specified according to such quantity. In other words, the larger the quantity is, the larger the number of the allotted sorting shelf segments becomes whereas the smaller the quantity is, the smaller the number of the allotted sorting shelf segments becomes. Accordingly, the value of y can be obtained with higher precision compared with the case where the types of articles are taken into account.

Furthermore, taking into account the volume of each article allows the proportional ratio of the sorting shelf segments allotted to the delivery destination of such selected subject to be specified according to such volume. In other words, irrespectively of whether or not the quantity is smaller, the larger the volume is, the larger the number of the sorting shelf segments becomes. Accordingly, the value of y can be obtained with much higher precision compared with the case where the quantities of articles are taken into account.

At the determination process of the step S1206, in the case where the x is larger than the np as well as the value of y is smaller than the maximum number of sorting shelf segments NP×np, such selected subject becomes must at the plurality of working stations WSi at the same period of time. In other words, there is likelihood that the conflict on the delivery shelf DS to store such selected subject between such working stations (at Step S1206: Yes). In this case, it is preferred that the idling time caused by such conflict on the delivery shelf DS between different working stations WS be overcome by dispersing such selected subject into different delivery shelves DS.

On the other hand, even when the x is larger than the np, just if the value of y is larger than the maximum number of sorting shelf segments NP×np, such selected subject is handled at the plurality of working stations at the different periods of times. In other words, the conflict on the delivery shelf DS to store such selected subject never occurs (at Step S1206: No). In this case, it is preferred that such selected subject be continuously issued out at the same working station WS by segmentally collective shifting such selected subject to the same delivery shelf DS.

Further, when the x is smaller than the np, the issuing-out operation is performed at the only one working station WS, so that the conflict on the delivery shelf DS to store such selected subject never occurs (at Step 1206: No). Thus, it is preferred that such selected subject be segmentally collectively shifted.

When there is likelihood that such conflict might occur (at Step S1206: Yes), such selected subject must not be shifted from one storage segment to the other storage segment. Accordingly, the order management apparatus 402 executes the setting process to adjust the pieces of such selected subject or article (at Step S1207) at the delivery shelves table 800. Then, the order management apparatus returns to the step S1204. The method of adjusting the pieces of the selected subject or article includes that by which the pieces of such selected subject or article are averaged out over the plurality of storage segments Qk-cd into which such selected subject or article is dispersed. For example, with reference to the delivery shelves table 800, when such selected subject is the article A, the number of pieces of the ID entry number ‘1’ is ‘7’ and the number of pieces of the ID entry number ‘9’ is ‘25’. The average number of pieces of the ID entry numbers ‘1’ and ‘7’ amount to ‘16’, so that the number of pieces of the ID entry number ‘9’ is reduced by nine into sixteen while the number of pieces of the ID entry number ‘1’ is increased by nine to sixteen, thereby, the number of pieces of the same kind of article being equally distributed among such different storage segments Qk-cd.

Further, there is a method by which the number of pieces of such selected subject or article is leveled out among the plurality of storage segments Qk-cd respectively to which such selected subject or article is dispersed such that such number of pieces as detected at the step S1202 is satisfied. For instance, when such selected subject is the article A, with reference to the order data table 1000, the number of pieces according to the order data on the ID entry number ‘1’ is ‘10’ and the number of pieces according to the order data on the ID entry number ‘3’ is ‘20’. On the other hand, with reference to the delivery shelves table 800, when such selected subject is the article A, the number of pieces of the ID entry number ‘1’ is ‘7’ and the number of pieces of the ID entry number ‘9’ is ‘25’.

Accordingly, the number of pieces ‘25’ of the ID entry number ‘9’ satisfies the number of pieces ‘22’ according to the order data on the ID entry number ‘3’ of the order data table 1000, but the number of pieces ‘7’ of the ID entry number ‘1’ does not satisfy the number of pieces ‘10’ according to the order data on the ID entry number ‘1’ of the order data table 1000. Thus, the number of pieces ‘25’ of the ID entry number ‘9’ is reduced by 3 into 22 while the number of pieces ‘7’ of the ID entry number ‘1’ is increased by 3 to 10 at the delivery shelves table 800, thereby, the pieces of the same kind of article being distributed among such different storage segments Qk-cd such that such pieces become appropriate for picking at each of such storage segments.

On the other hand, when there is no likelihood that such conflict might occur (at Step S1206: No), such selected subject is allowed to be segmentally collectively shifted from the one segment to the other segment. Accordingly, the order management apparatus 402 executes the setting process to segmentally collectively shift the pieces of such selected subject at the delivery shelves table 800 (at Step S1208). Then, the order management apparatus returns to the step S1204. The method of segmentally collective shifting such pieces includes that by which the entire pieces of such selected subject or article at the one storage segment are shifted to the other storage segment over the plurality of storage segments Qk-cd into which such selected subject or article is dispersed, by way of one example. In this case, by segmentally collective shifting such selected subject or article at the segment in which such article is stored with the smaller number of pieces to the storage segment in which such selected subject or article is stored with the larger number of pieces, it allows the segmentally collective shifting to be carried out with efficiency.

At the step S1204, in the case where there is no non-selected subject for determining whether or not it is to be segmentally collectively shifted (at Step S1204: No), the order management apparatus 402 ends the selection process (at Step S1101) of the subject for determining whether it is to be segmentally and collectively shifted.

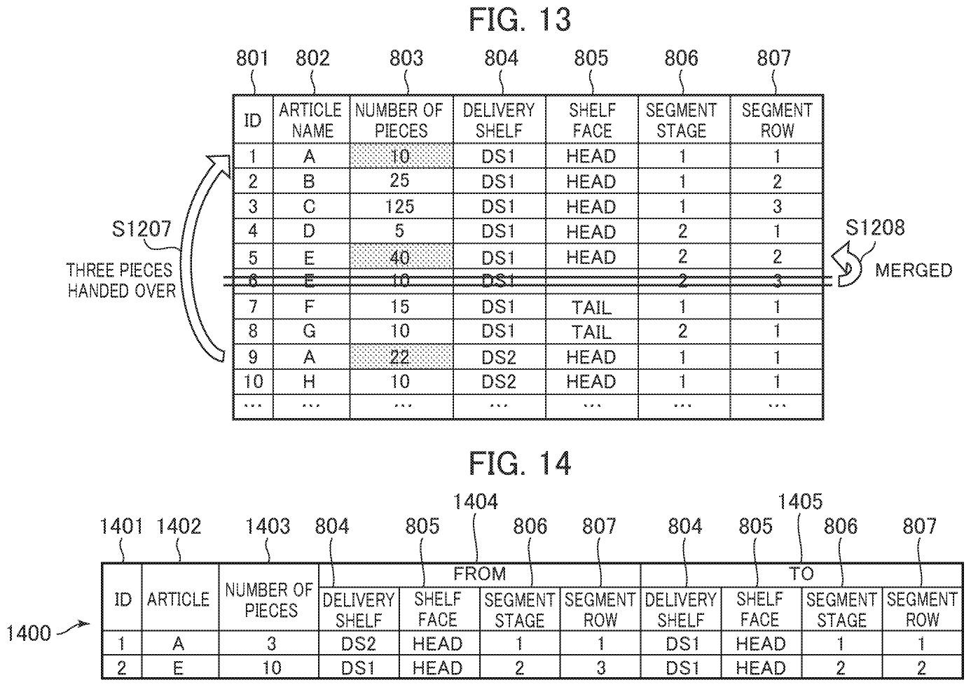

FIG. 13 is an explanatory view illustrating the segmentally collective shifting result at the delivery shelves table 800. In FIG. 13, it is illustrated that the step S1207 is executed for the article A corresponding to the selected subject for determining whether or not it is to be segmentally collectively shifted so that among the number of pieces of the ID entry number ‘9’, three of them are handed over to the ID entry number ‘1’; and further, the step S1208 is executed for the article E corresponding to such selected subject so that the entire number of pieces of the ID entry number ‘6’ is shifted to the ID entry number ‘5’.

FIG. 14 is an explanatory view illustrating the list in which the segmentally collective shifting result illustrated in FIG. 13 is tabled. The segmentally collective shifting result list 1400 is provided with an ID field 1401, an article field 1402, a number of pieces field 1403, a FROM field 1404 and a TO field 1405. One entry corresponding to such selected subject is constituted by the combination of the values of the respective fields 1401 to 1405.

The ID field 1401 is a memory field to store an ID in terms of value. The ID is identification information to specify such selected subject in a non-equivocal manner. The article field 1402 is a memory field to store the identification information of the selected subject or article for determining whether or not it is to be segmentally collectively shifted in terms of value. The number of pieces field 1403 is a memory field to store the number of pieces of such selected subject or article as specified in the article field 1402 in terms of value. The FROM field is a memory field to store the locational information of the originating delivery shelf or the originating delivery shelf from which the adjustment process is derived and is composed of the delivery shelf field 804, the shelf face field 805, the segment stage field 806 and the segment row field 807 all illustrated in FIG. 8. The TO field 1405 is a memory field to store the locational information of the destined delivery shelf or the delivery shelf to which such adjustment process is destined and is composed of the delivery shelf field 804, the shelf face field 805, the segment stage field 806 and the segment row field 807 all illustrated in FIG. 8.

The ID entry number ‘1’ indicates that three pieces of the article A corresponding to such selected subject which is subjected to such adjustment process at the step S1207 are shifted from the segment stage ‘1’ and the segment row ‘1’ of the shelf face ‘head’ of the delivery shelf DS2 to the segment stage ‘1’ and the segment row ‘1’ of the shelf face ‘head’ of the delivery shelf DS1. The ID entry number ‘2’ indicates that the entire pieces (10 pieces) of the article E corresponding to such selected subject and subjected to the segmentally collective shifting at the step S1208 are shifted from the segment stage ‘2’ and the segment row ‘3’ of the shelf face ‘head’ of the delivery shelf DS1 to the segment stage ‘2’ and the segment row ‘2’ of the shelf face ‘head’ of the delivery shelf DS1.

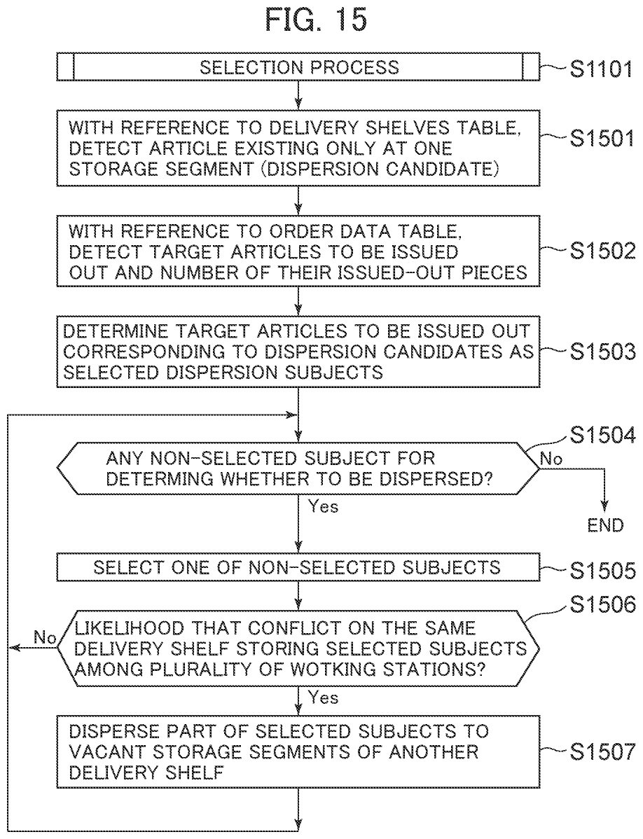

FIG. 15 is a flow chart illustrating the detailed process procedure example 2 of the selection process (at Step S1101) illustrated in FIG. 11. FIG. 15 is a flow chart to select the target article to be dispersed. The order management apparatus 402 detects an article existing only at one storage segment Qk-cd as a target article candidate to be dispersed with reference to the delivery shelves table 800 illustrated in FIG. 8 (at Step S1501).

More specifically, for instance, with reference to FIG. 8, the articles B to D and F to H corresponding to the ID entry numbers ‘2’ to ‘4’, ‘7’, ‘8’ and ‘10’ are those existing only at one storage segment Qk-cd, so that they correspond to such target article candidates to be dispersed.

To note, when the shipping request from the delivery destination is not completed on time or there is no shipping request, the order management apparatus 402 may add such articles as having been sequentially and frequently subjected to shipping requests to the target article candidates to be dispersed based on the past shipping data.

The order management apparatus 402, with reference to the order data table 1000 illustrated in FIG. 10, detects the target article to be issued out and the number of the pieces of such issued-out target article (at Step S1502). The step S1502 is the same as the step S1202 in operation.

The order management apparatus 402 determines the target article to be issued out corresponding to the target article candidate to be dispersed as the subject for determining whether or not it is to be dispersed (at Step S1503). More specifically, for example, the order management apparatus 402 determines such target article candidate as well as such target article to be issued out as such subject for determining whether or not it is to be dispersed. According to the above example, the articles B to D and F to H are detected as such target article candidates to be dispersed at the step S1501 and the articles A to H are detected at the step S1502. Accordingly, the order management apparatus 402 determines the articles B to D and F to H as such subjects for determining whether or not they are to be dispersed.

The order management apparatus 402 determines whether or not there is any non-selected subject for determining whether or not it is to be dispersed (at Step S1504). If in the affirmative (at Step S1504: Yes), the order management apparatus 402 selects one of such non-selected subjects for determining whether or not they are to be dispersed (at Step S1505).

The order management apparatus 402 determines whether or not there is likelihood that the conflict on the same delivery shelf DS having the selected subject for determining whether or not it is to be dispersed might occur among the plurality of working stations (at Step S1506). The determination process of the step S1506 is the same as that of the step S1206, so that its explanation is omitted to avoid redundancy (‘selected subject for determining whether or not it is to be segmentally collectively shifted’ being just rephrased with ‘selected subject for determining whether or not it is to be dispersed’).

When there is likelihood that such conflict might occur (at Step S1506: Yes), it requires that such conflict be avoided by such selected subject being dispersed. Accordingly, the order management apparatus 402 executes the setting process to disperse the article corresponding to such selected subject into the other vacant segments at the reproduced delivery shelves table 800 (at Step S1507). Then, the order management apparatus returns to the step S1504. Such other vacant segments correspond to those within the delivery shelves DS unrelated to such selected subject in order to avoid such conflict. The method of dispersing such selected subject includes that by which some or all of the pieces of such selected subject is dispersed into the vacant segments of one or more other delivery shelves DS, by way of one example. As with the number of pieces to be dispersed, the adjustment method at the step S1207 also applies.

On the other hand, when there is no possibility that such conflict might occur (at Step S1506: No), the order management apparatus returns to the step S1504, because there is no need to disperse such selected subject. When there is no non-selected subject for determining whether or not it is to be dispersed at the step S1504 (at Step S1504: No), the order management apparatus 402 ends the selection process (at the step S1101) for selecting the subject for determining whether or not it is to be dispersed.

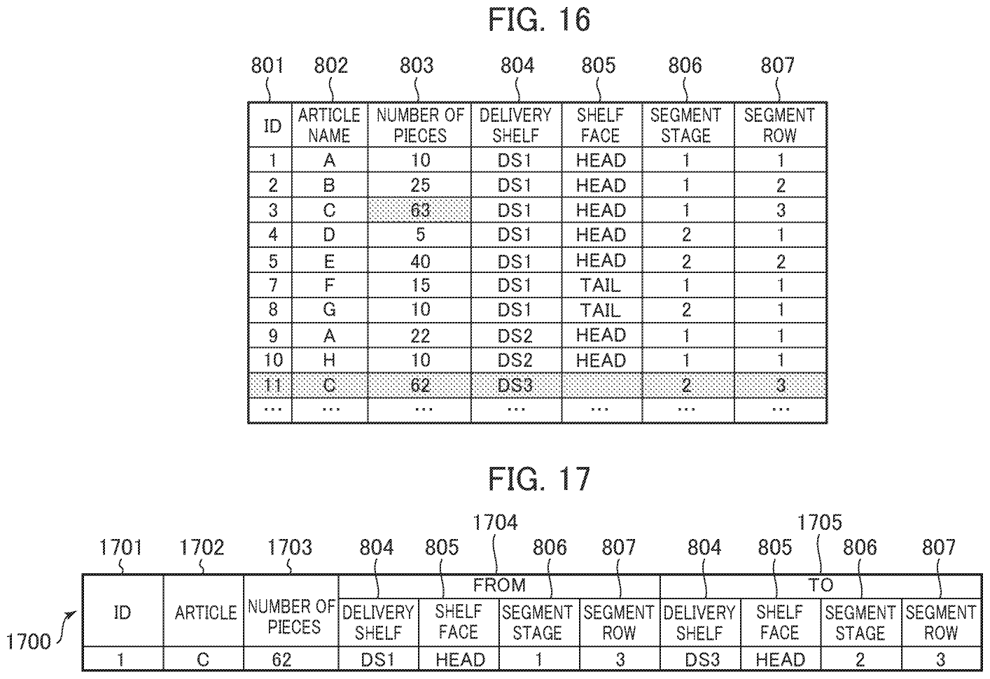

FIG. 16 is an explanatory view illustrating the dispersion determination result at the delivery shelves table 800. In FIG. 16, it is illustrated that the step S1507 is executed for the article C corresponding to such selected subject so that the ID entry number ‘3’ is subjected to dispersion or the number of pieces of the ID entry number ‘3’ is modified from 125 to 63. Further, according to such dispersion, the new ID entry number ‘11’ regarding the article C is made up. The number of pieces of the ID entry number ‘11’ is 62 dispersed from the ID entry number ‘3’. Moreover, the value of the delivery shelf field 804 of such new ID entry number is set such that a delivery shelf DS different from that DS1 of the ID entry number ‘3’ from which such dispersion is originated is entered in such field. Further, the values of the shelf face field 805, the segment stage field 806 and the segment row field 807 are set such that they indicate the vacant storage segments Qk-cd of the entered delivery shelf DS.

FIG. 17 is an explanatory view illustrating the list in which the dispersion determination result illustrated in FIG. 16 is tabled. The dispersion determination result list 1700 is provided with an ID field 1701, an article field 1702, a number of pieces field 1703, a FROM field 1704 and a TO field 1705. One entry corresponding to such selected subject is constituted by the combination of the values of the respective fields 1701 to 1705.

The ID field is a memory field to store an ID. The ID is identification information to specify such selected subject in a non-equivocal manner. The article field 1702 is a memory field to store the identification information of an article corresponding to such selected subject. The number of pieces field 1703 is a memory field to store the number of pieces into which such selected subject specified in the article field 1702 is dispersed. The FROM field 1704 is a memory field to store the location information of the originating delivery shelf from which such dispersion is derived and is composed of the delivery shelf field 804, the shelf face field 805, the segment stage field 806 and the segment row field 807 as illustrated in FIG. 8. The TOP field 1705 is a memory field to store the location information of the destined delivery shelf to which such dispersion is destined and is composed of the delivery shelf field 804, the shelf face field 805, the segment stage field 806 and the segment row field 807 as illustrated in FIG. 8.

The ID entry number ‘1’ indicates that 62 pieces of the article C corresponding to such selected subject subjected to dispersion at the step S1507 are dispersed from the segment stage ‘1’ and the segment row ‘3’ of the shelf face ‘head’ of the delivery shelf DS1 into the segment stage ‘2’ and the segment row ‘3’ of the shelf face ‘head’ of the delivery shelf DS3.

<Shift-Over Determination Process (at Step S1104)>

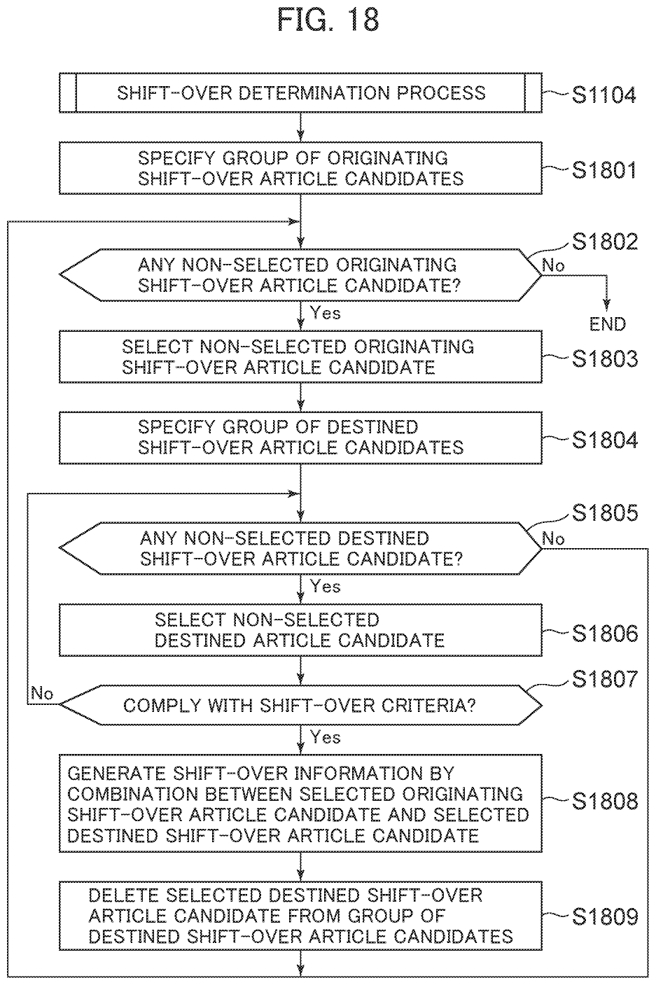

FIG. 18 is a flow chart illustrating the detailed process procedure example 3 of the shift-over determination process (at Step S1104) illustrated in FIG. 11. To begin with, the order management apparatus 402 specifies a group of the originating shift-over article candidates (at Step S1801). A group of the originating shift-over article candidates includes at least one originating shift-over article candidate. The originating shift-over article candidate indicates the article candidate to be shifted-over on one hand.

The order management apparatus 402 may select the article specified with the value of the article field 1402 as well as the value of the FROM field 1404 of the segmentally collective shifting determination result list 1400 illustrated in FIG. 14 as the group of the originating shift-over article candidates, by way of one example. Further, the order management apparatus 402 may select the article within the order data excepting the segmentally collective shifting determination list 1400 and the dispersion determination result list 1700 as the group of the originating shift-over article candidates. Moreover, the order management apparatus 402 may select the article whose number of pieces is more than the prescribed number or whose delivery destinations are more than the prescribed number. Which type of article is adopted for the originating shift-over article candidate is preliminarily set by the order management apparatus 402.

The order management apparatus 402 determines whether or not there is any non-selected originating shift-over article candidate (at Step S1802). If in the affirmative (at Step S1802: Yes), the order management apparatus 402 selects such non-selected originating shift-over article candidate (at Step S1803). The order management apparatus 402 specifies a group of the destined shift-over article candidates regarding the originating shift-over article candidate selected at the step S1803 (selected originating shift-over article candidate) (at Step S1804).

The group of the destined shift-over article candidates includes at least one destined shift-over article candidate. The destined shift-over article candidate is the article candidate subjected to shift-over on the other hand. When the originating article candidate is an article selected from the segmentally collective shifting determination result list 1400, the destined shift-over article candidate is an article specified with the value of the article field 1402 as well as the value of the TO field 1405 of the segmentally collective shifting determination result list 1400. When the originating shift-over article candidate is an article within the order data excepting the segmentally collective shifting determination result list 1400 and the dispersion determination result list 1700, the order management apparatus 402 may select another article within the order data excepting he segmentally collective shifting determination result list 1400 and the dispersion determination result list 1700 as the destined shift-over article candidate. However, the order management apparatus 402 excludes articles included in the shift-over information already generated at the step S1808 from the destined shift-over article candidates beforehand.

The order management apparatus 402 determines whether or not there is any non-selected destined shift-over article candidate (at Step S1805). If in the affirmative (at Step S1805: Yes), the order management apparatus 402 selects such non-selected destined shift-over article candidate (at Step S1806).

The order management apparatus 402 executes the determination process to determine whether the selected originating shift-over article candidate and the selected destined shift-over article candidate comply with the shift-over criteria (at Step S1805). The shift-over criteria are those to shift over the selected originating shift-over article candidate to the selected destined shift-over article candidate and to shift over the selected destined shift-over article candidate to the selected originating shift-over article candidate.

One example of such shift-over criteria is such that when the selected originating shift-over article candidate is shifted over to the selected destined shift-over article candidate, the number of the delivery shelves DS called for according to an order shall reduce compared with that before the shift-over.

For explanation, the case where the selected originating shift-over article candidate and the selected destined shift-over article candidate ate selected from the segmentally collective shifting determination result list 1400 is exemplified. It is assumed herein that the selected originating shift-over article candidate and the selected destined shift-over article candidate are referred to as Article J and the ordered articles (those within the order data) are referred to as Articles J and K while the article not in order is referred to as Article L; and the Article K is stored in the same delivery shelf DSx with the Article J or the selected originating shift-over article candidate while the Article L is stored in the same delivery shelf DSy with the Article J or the selected destined shift-over article candidate.

In this case, upon the Article J or the selected originating shift-over article candidate stored in the delivery shelf DSx being segmentally collectively shifted to the delivery shelf DSy in which the Article J or the selected destined shift-over article candidate is stored, the Article K is stored in the delivery shelf DSx while the Articles J and L are stored in the delivery shelf DSy. Accordingly, it results in the delivery shelves DSx and DSy being called for by the same working station WSi. When such shelves are called for at the same period of time, they dominate two gates Gij whereas when they are called for at the different timing, they are separately called for, so that the transport duration is doubled compared with the case where either of such delivery shelves is called for.

On the other hand, when the segmentally collective shifting direction is reversed, in other words, upon the Article J or the selected destined shift-over article candidate stored in the delivery shelf DSy being segmentally collectively shifted to the delivery shelf DSx in which the Article J or the selected originating shift-over article candidate is stored, the Articles J and K are stored in the delivery shelf DSx while the Article L is stored in the delivery shelf DSy. Accordingly, only the delivery shelf DSx is called for by the working station, so that it does without calling for the delivery shelf DSy. In other words, the ordered articles J and K can be issued out by only one transport.

In this way, when the selected originating shift-over article candidate is shifted over to the selected destined shift-over article candidate, such candidates result in complying with the shift-over criteria just when the number of the delivery shelves DS called for according to an order reduces compared with that before the shift-over.

The other example of the shift-over criteria is such that the combination of the selected originating shift-over article candidate with another article within the order data which is stored in the same delivery shelf DS with the selected originating shift-over article candidate corresponds to the combination of specific articles.

The combination of specific articles mentioned above is such that the conflict on the delivery shelf DS storing such combination of specific articles is capable of occurring at different working stations, by way of one example. More specifically, byway of one example, when the number of the issued-out pieces regarding the selected originating shift-over article candidate and the number of the issued-out pieces regarding another article within the order data which is stored in the same delivery shelf DS with the selected originating shift-over article candidate are both more than the prescribed numbers, the combination between them corresponds to such combination of specific articles.

Further, when the case number of the order data regarding the selected originating shift-over article candidate and the case number of the order data regarding another article within the order data which is stored in the same delivery shelf DS with the selected originating shift-over article candidate are both more than the prescribed case numbers, the combination between them corresponds to such combination of specific articles. Accordingly, the combination between the selected originating shift-over article candidate and another article within the order data which is stored in the same delivery shelf DS with the selected originating shift-over article candidate is considered in compliance with the shift-over criteria, thereby, allowing the conflict on the delivery shelf DS storing the plurality of articles, the number of which issued-out pieces (or the case number of which) is more than the prescribed number to be alleviated.

However, when the combination between the selected destined article candidate and such another article after the shift-over still corresponds to such combination of specific articles, such conflict is not overcome by such shift-over, and such combination is considered not in compliance with the shift-over criteria with such compliance rescinded.

It is assumed herein that the selected originating article candidate is referred to as Article J and the ordered article (article within the order data) is referred to as Article K. When the Articles J and K are stored in the same delivery shelf DS as well as the issued-out number of pieces of both the Articles J and K according to the order data are more than the prescribed numbers, the combination between the Articles J and K corresponds to such combination of specific articles. In other words, the Article J corresponding to the selected originating shift-over article candidate comes to comply with the shift-over criteria. It is assumed that the selected originating shift-over article candidate is referred to as Article L. When the issue-out number of pieces of both the Articles K and L to be stored in the same delivery shelf DS after the shift-over are more than the prescribed number, the combination between the Articles J and K correspond to such combination of specific articles. In this case, such conflict is not overcome after the shift-over, so that such combination is considered not in compliance with the shift-over criteria with such compliance rescinded.

When the shift-over criteria are not satisfied (at Step S1807: No), the order management apparatus returns to the step S1805. On the other hand, when the shift-over criteria are satisfied (at Step S1807: Yes), the order management apparatus 402 executes the setting process to generate shift-over information based on the combination between the selected originating shift-over article candidate and the selected destined shift-over article candidate (at Step S1808). The shift-over information as mentioned above is such that the destined shift-over of the selected originating shift-over article candidate is designated at the storage segment of the selected destined shift-over article candidate and the destined shift-over of the selected destined shift-over article candidate is designated at the storage segment of the selected originating shift-over article candidate.

For instance, when the combination between the selected originating shift-over article candidate and the selected destined shift-over article candidate is an entry of the segmentally collective shifting determination result list 1400, the order management apparatus 402 generates such shift-over information with the value of the FROM field 1404 of such entry switched over to the value of the To field 1405 thereof.

When the combination between the selected originating shift-over article candidate and the selected destined shift-over article candidate is an entry of neither the segmentally collective shifting determination result list 1400 nor the dispersion determination result list 1700, the order management apparatus 402 generates shift-over information including information on articles corresponding to the selected originating shift-over article candidates and the number of their pieces, information on the originating storage place (delivery shelf DS, shelf face, segment stage and segment row), information on articles corresponding to the selected destined shift-over article candidates and the number of their pieces, and the destined storage place (delivery shelf DS, shelf face, segment stage and segment row). The originating storage place corresponds to the value of the FROM field 1404 of the segmentally collective shifting determination result list 1400. The destined storage place corresponds to the value of the TO field 1405 of such determination result list 1400.

The order management apparatus 402 deletes the selected destined shift-over article candidate from the group of the destined shift-over article candidates (at Step S1809) and returns to the step S1802. When there is no non-selected originating shift-over article candidate at the step S1802, the order management apparatus 402 ends the shift-over determination process (at Step S1104) and proceeds to the step S1105.

To note, at the step S1105, the order management apparatus 402 generates transport instruction information according to the results of the segmentally collective shifting determination and the dispersion determination (at Step S1103) as well as the shift-over information corresponding to the result of the shift-over determination process (at Step S1104) and transmits such transport instruction information to the travel management device 403. For example, the order management apparatus 402 may generate the transport instruction information in the descending order of the number of pieces regarding the originating delivery shelf based on such results and transmit such information every time it is generated to the travel management device 403. Further, the order management apparatus 402 may generate the transport instruction information in the descending order of the case number of the order data regarding the originating delivery shelf based on such results and transmit such information every time it is generated to the travel management device 403.

Carrying out such preprocessing (at Step S904) before the issuing-out operation allows the conflict on the same delivery shelf DS among the plurality of working stations WSi during the issuing-out operation to be suppressed. Thus, the efficiency with which such issuing-out operation is performed can be enhanced.

Further, through the segmentally collective shifting selection process (at Step S1101) illustrated in FIG. 12, the target articles to be issued out which are dispersively stored over the plurality of storage segments can be segmentally collectively shifted to one storage segment. When a plurality of storage segments exists in the same delivery shelf DS, vacant storage segments can be incremented, which segments can be exploited for storing other articles. Accordingly, the efficiency with which such issuing-out operation is performed can be enhanced.

Moreover, when a plurality of storage segments exist in various delivery shelves DS as well, segmentally collective shifting the target articles to be issued out which are dispersively stored over the plurality of storage segments to one storage segment allows the vacant storage segments to be incremented. Additionally, by reducing the number of delivery shelves DS transported during the issuing-out operation so as to decrease the times of transport, it permits the idling time of such delivery shelves DS among the working stations WSi to be reduced or the duration of the issuing-out operation to be shortened, so that the efficiency with which such issuing-out operation is performed can be enhanced.

Further, through the dispersion selection process (at Step S1101) illustrated in FIG. 15, it allows the target article to be issued out which is stored in one storage segment to be dispersively stored into a plurality of delivery shelves DS, which permits a plurality of working stations WSi respectively to call for different delivery shelves DS even when the same target article to be issued out is issued out at the same period of time, thereby, permitting the conflict on the same delivery shelf DS among the plurality of working stations WSi to be suppressed. Accordingly, the efficiency with which such issuing-out operation is performed can be enhanced.

Additionally, through the shift-over process (at Step S1104) illustrated in FIG. 18, it allows a plurality of target articles to be issued out to be stored in the same delivery shelf as much as possible, which successfully leads to reducing the number of the transported delivery shelves DS or shortening the duration of the issuing-out operation. Accordingly, the efficiency with which such issuing-out operation is performed can be enhanced.

On top of the above, through the shift-over process (at Step S1104) illustrated in FIG. 18, it allows a plurality of target articles to be issued out, the number of the issued out pieces of which or the case number of which order data is large, to be dispersed into various delivery shelves DS, which successfully leads to suppressing the conflict on the same delivery shelf DS among the plurality of working stations WSi. Accordingly, the efficiency with which such issuing-out operation is performed can be enhanced.

To note, according to the above-described examples, the case where the auto carriage AC transports the delivery shelf DS is exemplified, but it may be arranged such that the delivery shelf DS itself automatically moves to the working station WSi.

It shall be appreciated that the present invention is not limited to the above-described examples, but can be modified into various manners with the incorporation of equivalent features within the gist of the accompanying scope of patent claims. For example, the above-describe examples are only intended for facilitating the persons skilled in the art to understand the present invention, so that the present invention is not necessarily limited to what covers the whole features described herein. Further, a part of the features according to a certain example may be replaced with those according to another example. Moreover, features according to another example may be added to those according to a certain example. Additionally, another feature may be added to a part of features according to each example or a part of such features may be replaced with another feature by deletion.

On top of the above, a part or the entirety of e.g. the above-described respective features, functions, processing units and processing means may be implemented in the form of hardware through designing the same with an integrated circuit or implemented in the form of software with a processor interpreting and executing programs to realize each function.

Such data as programs, tables and files to realize each function may be stored in a storage device such as a memory, a hard disk and SSD (Solid State Drive) or in a recording medium such as an IC card, an SD card and DVD.

Further, in the above description, control lines and data lines are disclosed as far as they are considered necessary for the sake of explanation, so that such complete control lines and data lines as required for packaging are not necessarily disclosed therein. In actual, it could be said that most of the features are interconnected with one another.

1. An order management apparatus to manage issuing-out operation of articles to be issued out employing plural delivery shelves to store the articles and plural working stations to issue out the articles stored in the delivery shelves transported to the working stations, the order management apparatus comprising a processor to execute a program and a memory device to store the program,
wherein the processor executes reception processing to receive at least one order including the articles to be issued out, the number of pieces of the articles to be issued out and delivery destinations of the articles to be issued out; determination processing to determine likelihood of conflict on a specific delivery shelf before the issuing-out operation of the articles to be issued out based on the order that while the issuing-out operation is over since the specific delivery shelf to store the articles to be issued out has been transported to the first working station, an instruction on the issuing-out operation for the articles to be issued out from the specific delivery shelf at the second working station occurs; and setting processing to set the number of pieces of the articles to be issued out to be stored within the specific delivery shelf or between the specific delivery shelf and another delivery shelf based on the determination on the likelihood of the conflict on the specific delivery shelf.

2. The order management apparatus according to claim 1, wherein at the determination processing, the processor determines likelihood of the conflict on the specific delivery shelf before the issuing-out operation of the articles to be issued out based on the number of the working stations to perform the issuing-out operation of the articles to be issued out; the number of first segments provided on a sorting shelf to sort out the articles to be issued out for each of the delivery destination at the working station; the number of second segments allotted to the delivery destinations as a whole of the articles to be issued out as a whole included in the order at the sorting shelves of the plural working stations; and the number of third segments allotted to the delivery destinations of the articles to be issued out at the sorting shelves of the plural working stations.

3. The order management apparatus according to claim 2, wherein at the determination processing, the processor calculates the number of the third segments based on a proportion between the articles to be issued out and other articles to be issued out with the same delivery destination as the articles to be issued out; and determines the likelihood of the conflict on the specific delivery shelf before the issuing-out operation of the articles to be issued out based on the number of the working stations to perform the issuing-out operation of the articles to be issued out, the number of the first segments, the number of the second segments, and the calculated number of the third segments.

4. The order management apparatus according to claim 3, wherein at the determination processing, the processor calculates the number of the third segments based on the number of kinds of the articles to be issued out and the other articles to be issued out as the proportion between the articles to be issued out and the other articles to be issued out with the same delivery destination as the articles to be issued out.

5. The order management apparatus according to claim 3, wherein at the determination processing, the processor calculates the number of the third segments based on quantity of each of the kinds of the articles to be issued out and the other articles to be issued out as the proportion between the articles to be issued out and the other articles to be issued out with the same delivery destination as the articles to be issued out.

6. The order management apparatus according to claim 3, wherein at the determination processing, the processor calculates the number of the third segments based on a volume of each of the kinds of the articles to be issued out and the other articles to be issued out as the proportion between the articles to be issued out and the other articles to be issued out with the same delivery destination as the articles to be issued out.

7. The order management apparatus according to claim 2,
wherein the processor executes determination processing to determine the articles to be issued which are dispersed into plural segments within a group of the delivery shelves including the specific delivery shelf among the plural delivery shelves as subjects for determining whether or not they are to be segmentally collectively shifted,
wherein at the determination processing, the processor determines the likelihood of the conflict on the specific delivery shelf before the issuing-out operation of the subjects based on the number of the working stations to perform the issuing-out operation of the subjects; the number of the first segments provided on the sorting shelf to sort out the subjects for each of the delivery destinations at the working station; the number of the second segments allotted to the delivery destinations as a whole of the articles to be issued out as a whole included in the order at the sorting shelves at the plural working stations; and the number of the third segments allotted to the delivery destinations of the subjects at the sorting shelves of the plural working stations, and
wherein at the setting processing, the processor sets the number of the pieces of the subjects to be stored in the plural segments based on the determination on the likelihood of the conflict on the specific delivery shelf.

8. The order management apparatus according to claim 7, wherein at the setting processing, when it is determined that there is no likelihood on the conflict on the specific delivery shelf, the processor sets the number of the pieces of the subjects to be stored within the plural segments such that the number of the plural segments reduces.

9. The order management apparatus according to claim 8, wherein at the setting processing, the processor makes a setting such that all the pieces of the subjects stored in the specific delivery shelf are stored in a segment of another delivery shelf in which the other articles to be issued out are stored, the subjects being stored in the segment.

10. The order management apparatus according to claim 2,
wherein the processor executes determination processing to determine the articles to be issued out which are stored only at one segment within the specific delivery shelf as subjects for determining whether or not they are to be dispersed,
wherein at the determination processing, the processor determines the likelihood of the conflict on the specific delivery shelf before the issuing-out operation of the subjects based on the number of the working stations to perform the issuing-out operation of the subjects; the number of the first segments provided on the sorting shelf to sort out the subjects for each of the delivery destinations at the working station; the number of the second segments allotted to the delivery destinations as a whole of the articles to be issued out as a whole included in the order at the sorting shelves of the plural working stations; and the number of the third segments allotted to the delivery destinations of the subjects at the sorting shelves of the plural stations, and
wherein at the setting processing, when it is determined that there is likelihood on the conflict on the specific delivery shelf, the processor sets the number of the pieces of the subjects to be stored between the specific delivery shelf and the another delivery shelf.

11. The order management apparatus according to claim 1,
wherein at the determination processing, the processor determines whether or not the number of pieces of the first articles to be issued out and the number of pieces of the second articles to be issued out, the first and second articles to be issued out being stored in the specific delivery shelf, are both more than a prescribed number, and
wherein at the setting processing, the processor shifts over information on either of the first articles to be issued out and the second articles to be issued out to information on the articles stored in the another delivery shelf.

12. The order management apparatus according to claim 1,
wherein at the determination processing, the processor determines whether or not the case number of order regarding the first articles to be issued out and the number of case number of order regarding the second articles to be issued out, the first and second articles to be issued out being stored in the specific delivery shelf, are both more than a prescribed number, and
wherein at the setting processing, the processor shifts over information on either of the first articles to be issued out and the second articles to be issued out to information on the articles stored in the another delivery shelf.

13. An order management method by an order control apparatus to manage issuing-out operation of articles to be issued out employing plural delivery shelves to store the articles and plural working stations to issue out the articles stored in the delivery shelves transported to the working stations, the order management apparatus comprising a processor to execute a program and a memory device to store the program,
wherein the processor executes reception processing to receive at least one order including the articles to be issued out, the number of pieces of the articles to be issued out and delivery destinations of the articles to be issued out;
determination processing to determine likelihood of conflict on the specific delivery shelf before the issuing-out operation of the articles to be issued out based on the order that while the issuing-out operation is over since the specific delivery shelf to store the articles to be issued out has been transported to the first working station, an instruction on the issuing-out operation for the articles to be issued out from the specific delivery shelf at the second working station occurs; and
setting processing to set the number of pieces of the articles to be issued out to be stored within the specific delivery shelf or between the specific delivery shelf and another delivery shelf based on the determination on the likelihood of the conflict on the specific delivery shelf.

14. An order management program to make a processor that manages issuing-out operation of articles to be issued out employing plural delivery shelves to store the articles and plural working stations to issue out the articles stored in the delivery shelves transported to the working stations execute:
reception processing to receive at least one order including the articles to be issued out, the number of pieces of the articles to be issued out and delivery destinations of the articles to be issued out;
determination processing to determine likelihood of conflict on the specific delivery shelf before the issuing-out operation of the articles to be issued out based on the order that while the issuing-out operation is over since the specific delivery shelf to store the articles to be issued out has been transported to the first working station, an instruction on the issuing-out operation for the articles to be issued out from the specific delivery shelf at the second working station occurs; and
setting processing to set the number of pieces of the articles to be issued out to be stored within the specific delivery shelf or between the specific delivery shelf and another delivery shelf based on the determination on the likelihood of the conflict on the specific delivery shelf.
